(19) United States
(12) Patent Application Publication
(10) Pub. No.: US 2025/0022091 A1
(43) Pub. Date: Jan. 16, 2025

(54) OPTIMIZED NUMERICAL COMPUTATION FRAMEWORK FOR A GRAPHICS PROCESSING UNIT

(71) Applicant: Bayris Inc., Mountain View, CA (US)

(72) Inventor: Jorge Campos, Mountain View, CA (US)

(73) Assignee: Bayris Inc., Mountain View, CA (US)

(21) Appl. No.: 18/770,616

(22) Filed: Jul. 11, 2024

Related U.S. Application Data
(60) Provisional application No. 63/526,167, filed on Jul. 11, 2023.

(51) Int. Cl. G06T 1/20

(52) U.S. Cl. CPC G06T 1/20

(57) ABSTRACT

Disclosed are various embodiments of performing a numerical operation, within a kernel of a graphics processing unit (GPU), on a matrix that references at least a subset of a numeric array. In one aspect, the disclosed system can create, in a fast memory of the GPU, a first object that represents a matrix, and is accessible by a GPU program that performs a numerical operation on the matrix in the kernel of the GPU. The first object's matrix data type includes functions that implement numerical operations on the reference matrix. The system also creates a second object in a global memory of the GPU for storing metadata of the reference matrix, such that this metadata facilitates accessing a group of cells that are associated with the reference matrix. The system can execute the numerical operation on the reference matrix in response to a GPU program calling the matrix function.

### CROSS-REFERENCE TO RELATED APPLICATION

This application claims the benefit of U.S. Provisional Patent Application Ser. No. 63/526,167, entitled “OPTIMIZED DESIGN OF A GPU-BASED LINEAR ALGEBRA FRAMEWORK,” by inventor Jorge Campos, Attorney Docket Number BRI23-01-1PSP, filed on 11 Jul. 2023, the contents of which are incorporated by reference herein.

### TECHNICAL FIELD

The present disclosure generally relates to optimizing executions of numerical programs. More specifically, the present disclosure relates to accelerating executing a numerical program by offloading numerical computations onto a kernel of a graphics processing unit (GPU).

### BACKGROUND

Graphics Processing Units (GPUs) are powerful tools for implementing parts of a program/application as a concurrent program that can be executed across thousands of processor cores on one microchip. Unfortunately, implementing programs on GPUs is not a trivial task, because these processor cores are oftentimes distributed across multiple GPU multiprocessor blocks (e.g., multiple Nvidia CUDA Streaming Multiprocessor blocks, or “SM blocks”), and the application programmers oftentimes need to perform considerable effort to map their program's data structure across the GPU's memory hierarchy.

FIG. 1A illustrates an exemplary memory hierarchy of a modern GPU architecture. Generally, a GPU has three primary memory tiers:
Global memory: global memory is the largest memory tier of a GPU (typically having a size of many gigabytes), but it is also the slowest memory tier inside the GPU.
Shared memory: shared memory can be approximately 10× faster than the global memory, but it is unique to each SM block, and there is not very much shared memory per SM block (at least 48 KB for most GPUs, and approximately 100 KB-192 KB of dynamic shared memory for some newer GPUs).
Register memory: each processor core has a corresponding private register memory, that other processor cores may not access directly. A GPU oftentimes has 255 4-byte registers per GPU processing core, and this number may be lower if multiple processing threads are assigned to a GPU processing core.
Computer system random access memory (i.e., “RAM,” not shown in FIG. 1): GPU programs may also make use of a computer system's RAM via a unified memory allocation that accesses a system's memory by copying pages to the GPU's global memory on-demand; however, the interface between the computer system's RAM and the GPU's global memory is often the slowest interface of a GPU program execution.

Mapping an application into a program that maximizes utilization of a GPU's resources is a tedious process that requires considerable experimentation. Programmers oftentimes choose to “accelerate” their numerical programs, by programming a CPU-based application to offload small snippets of code into various GPU “kernels” for the GPU to accelerate. A GPU kernel is a function that runs on a GPU, and can be launched using CPU instructions (e.g., from a CPU-based application) to perform an operation in parallel across multiple threads across the GPU. FIG. 1B shows how a program 178 running on a CPU 160 of a host computer system 150 offloads some computations onto a GPU device 180 (or “GPU 180”) via a GPU kernel. Specifically, program 178 can manage metadata 174 primarily in the host computer's RAM module 170 (also referred to as “host RAM 170” or “host RAM module 170” hereinafter), while offloading associated computations onto a GPU device 180 by:
Step 1: copying a host-side numeric array 172 to global memory 182 of GPU device 180, via a PCI interface 190;
Step 2: passing metadata 174, and a device-side numeric array pointer 176 (which points to a device-side numeric array 184 on GPU global memory 182), to GPU device 180 via PCI interface 190, as function parameters to a task-specific GPU kernel function configured to perform a narrow task on numeric array 184; and
Step 3: copying the results in device-side numeric array 184 from GPU global memory 182 back to RAM module 170, via PCI interface 190.

Applications oftentimes need to perform a large number of operations on numeric arrays. Hence, a typical GPU-accelerated application may need to repeatedly perform at least Step 2 described above to make a plurality of calls to one or more GPU kernels. Applications oftentimes need to also perform Steps 1 and 3 described above to synchronize the data in numeric array 184 in GPU global memory 182 to the data stored in numeric array 172 in host RAM module 170, so that the application running on CPU 160 can perform post-processing before invoking further GPU kernels. Unfortunately, operations involved in Steps 1-3 listed above require sending data across PCI interface 190, which is a significantly slower process than accessing RAM module 170 from CPU 160, or directly accessing GPU global memory 182 from within GPU device 180. Hence, while accelerating an application by offloading computations onto GPU device 180 can provide speed improvements for large numeric arrays, this gain is also associated with a significant overhead cost from PCI interface 190 that makes it impractical to utilize GPU device 180 on some applications operating on smaller numeric arrays.

As an example, some libraries in the Python™ ecosystem are “GPU-accelerated,” which means that a special-purpose task in a Python™ library (e.g., an addition operation across two large arrays) can be dispatched to a GPU (when a GPU is available) via a small, dedicated GPU kernel that can perform only that specific task. The Python™ application's program flow and metadata is managed by the CPU, which can perform Steps 1-3 listed above to launch a GPU kernel for the special-purpose task on the GPU, before proceeding with further operations in the Python™ application. However, this programming approach has a considerable overhead cost due to Steps 1-3 listed above, because it requires extensive additional code and memory transfers for the CPU-based program to dispatch a GPU kernel to the GPU for each individual numerical task, and retrieve the results back to RAM module 170 before performing other numerical tasks. Therefore, a program (e.g., program 178 in computer system 150 of FIG. 1B) that runs a large number of GPU-accelerated tasks would suffer a significant overhead from the large amount of communications that would be required through PCI interface 190 between the CPU and the GPU.

Hence, what is needed is an improved GPU-based numerical computation framework that can accelerate CPU-based numerical programs without the above-described problems.

### SUMMARY

In one aspect, a process for performing a numerical operation, within a kernel of a graphics processing unit (GPU), on a reference matrix that references at least a subset of a primary numeric array is disclosed. During operation, the process may begin by creating, in a fast memory of the GPU, a first object that is accessible by a GPU program that performs a numerical operation on the reference matrix in the kernel of the GPU, wherein the first object corresponds to a data type that includes a function that implements the numerical operation on the reference matrix. The process also creates a second object in a global memory of the GPU for storing a first set of metadata of the reference matrix. Next, the process initializes a first attribute in the first set of metadata of the second object to a value that references a group of cells that are associated with the reference matrix, wherein the group of cells corresponds to at least a subset of cells in the primary numeric array allocated in the global memory of the GPU. The process further initializes a first reference variable in the first object to reference at least the first attribute in the second object. The process subsequently executes the numerical operation on the reference matrix in response to the GPU program issuing a GPU function call to the function of the first object.

In some embodiments, the fast memory is either a register memory of the GPU or a shared memory of the GPU.

In some embodiments, the process executes the numerical operation by performing a computation on a first cell in the group of cells of the reference matrix, based at least on the first attribute of the first set of metadata.

In some embodiments, the process executes the numerical operation on the cell based at least on the first attribute by performing the steps of: (1) obtaining reference-matrix coordinates that correspond to the first cell of the reference matrix, wherein the reference-matrix coordinates are relative to cells referenced by the reference matrix; (2) computing, for the reference-matrix coordinates and based at least on the first attributes, array coordinates for accessing the first cell from the primary numerical array, wherein the array coordinates are relative to the primary numerical array; and (3) retrieving a reference pointer to the cell of the primary numeric array, using the array coordinates.

In some embodiments, the first attribute in the first set of metadata of the second object specifies a matrix-shape vector associated with the reference matrix. Moreover, a respective element of the matrix-shape vector corresponds to a dimension of the reference matrix and specifies the number of cells along the corresponding dimension of the reference matrix.

In some embodiments, the first set of metadata of the second object further includes a second attribute selected from the group composed of: (1) an array-stride vector associated with the reference matrix, wherein a respective element of the array-stride vector corresponds to a dimension of the reference matrix and specifies a number of cells to skip in the primary numerical array between adjacent cells of the reference matrix along the corresponding dimension; and (2) an array-offset vector associated with the reference matrix, wherein a respective element of the array-offset vector corresponds to a dimension of the reference matrix and specifies a starting position in the primary numerical array for the corresponding dimension of the reference matrix.

In some embodiments, the process further includes the step of creating a third object in the global memory of the GPU to manage data and metadata resources for the primary numeric array in the global memory.

In some embodiments, the third object includes a second set of metadata of the primary numeric array, and the process can update a second attribute in the second object to a value from the second set of metadata in the third object.

In some embodiments, the process further includes the steps of: (1) receiving array coordinates that correspond to the first cell of the primary numeric array, wherein the array coordinates are relative to the primary numerical array; and (2) retrieving a reference pointer, to the first cell for the array coordinates, based at least on the second attribute of the second set of metadata.

In some embodiments, the function of the first object includes one of: (1) an element-wise operation; (2) a row-wise operation; (3) a column-wise operation; (4) a cross-product operation; (5) a linear algebra computation; (6) a statistical computation; and (7) a time-series computation.

In another aspect, a graphics processing unit (GPU) managing a data structure that facilitates performing numerical computations on a matrix within the GPU is disclosed. The GPU can include a fast memory, wherein the fast memory stores a first object that is accessible by a GPU program that performs a numerical operation on the reference matrix in the kernel of the GPU. Note that the first object corresponds to a data type that includes a function that implements the numerical operation on the reference matrix. The GPU also includes a global memory, wherein the global memory stores a second object that is used to store a first set of metadata of the reference matrix. The GPU further includes at least one GPU processing core coupled to both the fast memory and the global memory and configured to run at least one processing thread, wherein the processing thread is further configured to: (1) create the first object in the fast memory; (2) create the second object in the global memory; (3) initialize a first attribute in the first set of metadata of the second object to a value that references a group of cells that are associated with the reference matrix, wherein the group of cells corresponds to at least a subset of cells in the primary numeric array allocated in the global memory of the GPU; (4) initialize a first reference variable in the first object to reference at least the first attribute in the second object; and (5) execute the numerical operation on the reference matrix in response to the GPU program issuing a GPU function call to the function of the first object.

In some embodiments, the fast memory is either a register memory of the GPU or a shared memory of the GPU.

In some embodiments, the at least one thread is configured to execute the numerical operation by performing a computation on a first cell in the group of cells of the reference matrix, based at least on the first attribute of the first set of metadata.

In some embodiments, the at least one thread is further configured to execute the numerical operation on the cell by: (1) obtaining reference-matrix coordinates that correspond to the first cell of the reference matrix, wherein the reference-matrix coordinates are relative to cells referenced by the reference matrix; (2) computing, for the reference-matrix coordinates and based at least on the first attributes, array coordinates for accessing the first cell from the primary numerical array, wherein the array coordinates are relative to the primary numerical array; and (3) retrieving a reference pointer to the cell of the primary numeric array, using the array coordinates.

In some embodiments, the first attribute in the first set of metadata of the second object specifies a matrix-shape vector associated with the reference matrix. Moreover, a respective element of the matrix-shape vector corresponds to a dimension of the reference matrix and specifies the number of cells along the corresponding dimension of the reference matrix.

In some embodiments, the first set of metadata of the second object further comprises a second attribute selected from the group composed of: (1) an array-stride vector associated with the reference matrix, wherein a respective element of the array-stride vector corresponds to a dimension of the reference matrix and specifies a number of cells to skip in the primary numerical array between adjacent cells of the reference matrix along the corresponding dimension; and (2) an array-offset vector associated with the reference matrix, wherein a respective element of the array-offset vector corresponds to a dimension of the reference matrix and specifies a starting position in the primary numerical array for the corresponding dimension of the reference matrix.

In some embodiments, the global memory of the GPU further stores and uses a third object to manage data and metadata resources for the primary numeric array in the global memory.

In some embodiments, the third object includes a second set of metadata of the primary numeric array. Moreover, the at least one thread is further configured to update a second attribute in the second object to a value from the second set of metadata in the third object.

In some embodiments, the at least one thread is further configured to: (1) receive array coordinates that correspond to the first cell of the primary numeric array, wherein the array coordinates are relative to the primary numerical array; and (2) retrieve a reference pointer, to the first cell for the array coordinates, based at least on the second attribute of the second set of metadata.

In some embodiments, the GPU is one of the following: (1) a general-purpose GPU (GPGPU) processor; (2) a shared-memory multiprocessor or symmetric multiprocessor (SMP); (3) a stream processor (SP); (4) an integrated graphics processing unit (IGPU); and (5) a hybrid GPU.

### BRIEF DESCRIPTION OF THE DRAWINGS

The structure and operation of the present disclosure will be understood from a review of the following detailed description and the accompanying drawings in which like reference numerals refer to like parts and in which:

FIG. 1A illustrates an exemplary memory hierarchy of a modern GPU architecture.

FIG. 1B shows how a program running on a CPU of a host computer system offloads some computations onto a GPU device via a GPU kernel.

FIG. 2A illustrates an exemplary data structure for managing a matrix variable's data and metadata of the disclosed GPU numerical system across the GPU memory hierarchy in accordance with some embodiments described herein.

FIG. 2B illustrates a process for creating and initializing a MatrixVar matrix variable in accordance with some embodiments described herein.

FIG. 3A illustrates an exemplary ultra-lightweight MatrixVar object that implements the MatrixVar object in FIG. 2 in accordance with some embodiments described herein.

FIG. 3B illustrates another exemplary ultra-lightweight MatrixVar object that alternatively implements the MatrixVar object in FIG. 2 in accordance with some embodiments described herein.

FIG. 3C illustrates yet another exemplary ultra-lightweight MatrixVar object that implements the MatrixVar object in FIG. 2 in accordance with some embodiments described herein.

FIG. 3D illustrates still another exemplary ultra-lightweight MatrixVar object that implements the MatrixVar object in FIG. 2 in accordance with some embodiments described herein.

FIG. 4 illustrates a process for implementing a flexible assignment operation for MatrixVar objects, which supports both shallow copying and aliasing in accordance with some embodiments described herein.

FIG. 5 illustrates two exemplary MatrixVar objects that reference the same or different portions of a numeric array in accordance with some embodiments described herein.

FIG. 6 illustrates two exemplary MatrixVar objects aliasing the same GlobalMatrixReference in accordance with some embodiments described herein.

FIG. 7 illustrates a process for caching a MatrixMeta metadata object in a GPU shared memory, for a MatrixVar object stored in a corresponding GPU global memory, in accordance with some embodiments described herein.

FIG. 8 illustrates an exemplary MatrixVar object stored in an exemplary global memory of a GPU in accordance with some embodiments described herein.

FIG. 9 illustrates an exemplary MatrixVar object stored in a shared memory of a GPU in accordance with some embodiments described herein.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

Some embodiments of this disclosure provide a graphics processing unit (GPU) numerical-processing system (hereinafter referred to as “GPU numerical system” or “system” below), that executes from within a GPU kernel to manage a GPU's resources for a numerical program so that the numerical program can run efficiently within the GPU kernel. The GPU numerical system can implement a wide variety of numerical operations (e.g., linear algebra or timeseries operations) that operate on matrix data, and run from within the GPU kernel. Hence, the numerical program can use the GPU numerical system to perform a plurality of complex operations on numerical data from within the GPU kernel.

In some embodiments, a GPU kernel is a function that runs on the GPU's processor cores, and can be launched by CPU instructions as an entry point to the embodiments of the GPU numerical system. The GPU kernel can also launch “device-side” GPU functions (hereinafter also referred to as “GPU device functions” or “device functions”), that also run on the GPU's processor cores.

The GPU numerical system includes a program, which runs on the GPU's processor cores and manages the GPU's computation resources (e.g., the GPU memory hierarchy and available GPU threads, hereinafter referred to as the “GPU's resources”) to efficiently perform numerical computations on a multi-dimensional array of one, two, or more dimensions (wherein the multi-dimensional array is hereinafter referred to as a “matrix”) residing in the GPU's global memory. The GPU numerical system can efficiently create and/or manage a matrix's metadata within the GPU's resources, such as to efficiently manage the use of the GPU's shared memory and register memory layers to temporarily store a matrix's metadata, and can dispatch a linear algebra operation onto a multitude of GPU cores across one or more GPU simultaneous multiprocessor or streaming multiprocessor units (hereinafter referred to as SM units).

In some embodiments, the GPU that can be used in the disclosed GPU numerical system may be a general-purpose GPU (GPGPU) processor, a stream processor (SP), or a shared-memory multiprocessor or symmetric multiprocessor (SMP). Alternatively, the GPU in the GPU numerical system may be an integrated graphics processing unit (IGPU) or a hybrid GPU, which can make use of the host computer system's random-access memory (RAM) for at least a portion of the GPU's global memory layer. Hereinafter, the term “GPU” may refer to any of a GPU, a GPGPU, a stream processor (SP) or shared-memory multiprocessor or symmetric multiprocessor (SMP) that includes dedicated on-board global memory, an IGPU that uses the host computer's RAM as the IGPU's global memory layer, and/or any SP, SMP, GPGPU, GPU, or hybrid GPU that includes dedicated global memory and may also utilize RAM as extended global memory. For example, in some embodiments the GPU may be a GPU from Nvidia Corporation, comprising multiple Nvidia CUDA Streaming Multiprocessor blocks, or “SM blocks.” The disclosed GPU numerical system can improve the performance of numerical and linear algebra programs whose control flow is managed from within a kernel function running on the GPU, for example, by copying metadata from the global memory layer to shared memory to improve the performance of access operations to a multi-dimensional array.

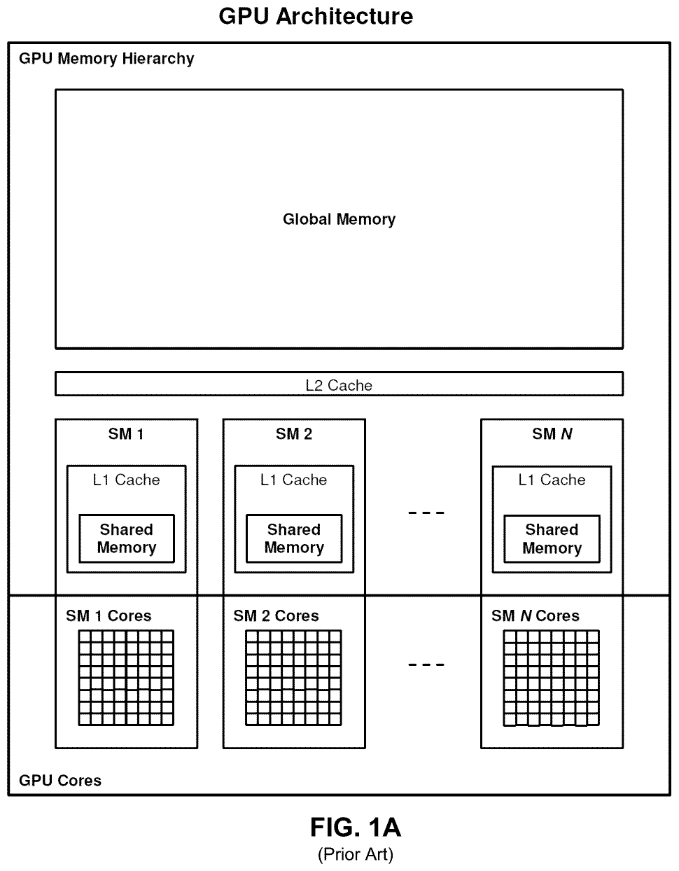

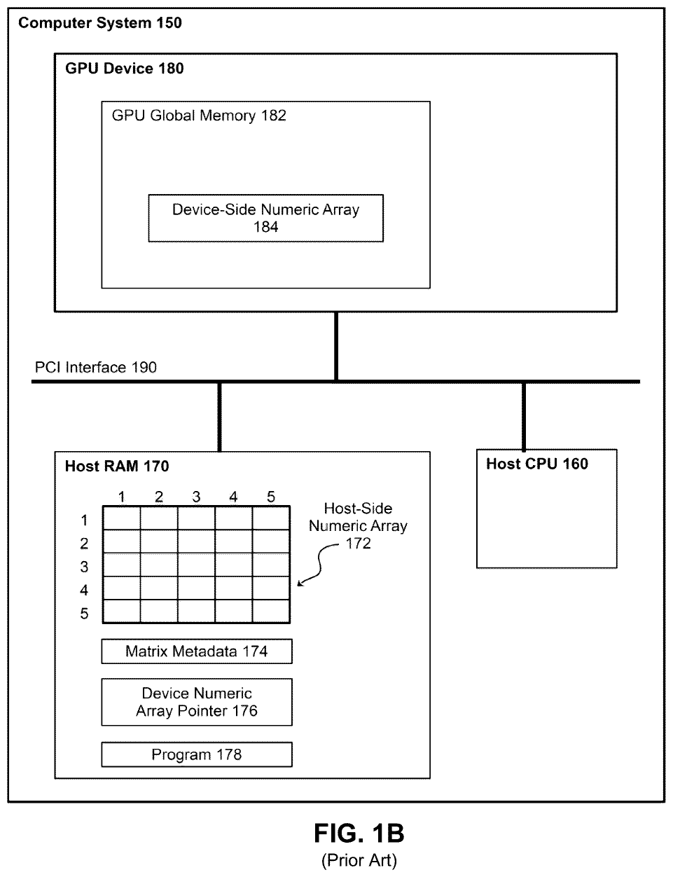

A programmer can use the GPU numerical system to implement a large numerical program that resides and runs within the GPU's resources by compiling the GPU numerical system into the binary program, and invoking the numerical and/or linear algebra operations from a GPU kernel or from a GPU device-side function dispatched directly or indirectly by a GPU kernel. This configuration allows the large numerical program to avoid slow data transfers from a computer's RAM to the GPU's resources that is otherwise required by a host-side application (e.g., program 178 shown in FIG. 1B whose matrix metadata and linear-algebra operations are managed and dispatched by host-side CPU 160).

Moreover, the shared memory and/or register memory layers of the GPU are not guaranteed to hold their value across GPU kernel invocations. Hence, using the disclosed GPU numerical system to implement a complete numerical program in a GPU kernel has another significant benefit: it allows an advanced numerical program to implement a “fused” solution, that leverages the shared memory of the GPU to implement multiple computation steps in a single GPU kernel that would have otherwise been implemented in separate GPU kernels.

The GPU numerical system includes data structures for configuring matrix metadata stored in the GPU memory hierarchy, and includes operations executed by one or more GPU processing threads that facilitate creating, referencing, updating, and/or destroying a matrix variable. A matrix variable of the GPU numerical system serves as an entry point to the functionalities of the GPU numerical system. In various embodiments, a matrix variable is implemented by a small binary object that includes a reference to matrix metadata stored in a GPU's global memory or shared memory; the matrix variable also includes a multitude of numerical operations (e.g., linear algebra operations) that can be performed on one or more matrices accessible by the GPU within a GPU kernel.

Moreover, the matrix metadata (which is referenced to by the matrix variable) can include a pointer to a numeric array stored in global memory accessible by the GPU device, index information for accessing the numeric array (or a subset of the numeric array), and/or a plurality of metadata associated with the data stored by the numeric array (e.g., row timestamp or index information, column name information, matrix name, a string for a respective column's units, etc.). The GPU numerical system can automatically manage the placement of the matrix metadata in the global memory and/or the shared memory to automatically balance the convenience associated with using a large amount of GPU's global memory and the efficiency of accessing metadata from the GPU's shared memory layer (e.g., in the GPU's L1 cache).

In some embodiments, the GPU numerical system comprises three primary components: a GPU management framework, a matrix management framework, and a linear algebra library. These components work in concert to provide a comprehensive solution for efficient numerical computations on a GPU.

The GPU management framework offers fine-grained control over GPU resources. The GPU numerical system supports, and allows a GPU program to select from, the following GPU global synchronization levels: a full GPU-grid synchronization level (wherein in the full GPU-grid synchronization level, a synchronization operation applies to all GPU thread blocks across the GPU grid); a GPU thread-block synchronization level (wherein in the GPU thread-block synchronization level, a synchronization operation applies to threads within a respective GPU thread block, but the respective GPU thread block continues to run asynchronously relative to other GPU thread blocks); and a GPU-warp synchronization level (wherein in the GPU-warp synchronization level, a synchronization operation applies to threads within a respective GPU warp, but the respective GPU warp continues to run asynchronously relative to other GPU warps). A GPU program can configure the disclosed GPU numerical system to move from a first global synchronization level (e.g., the full GPU-grid synchronization level) to a second global synchronization level that is lower than the first synchronization level (e.g., the GPU thread-block synchronization level) at runtime, for the duration of a code block of the GPU program. The GPU numerical system may then return to the first global synchronization level at the end of that code block. Moreover, a GPU program can invoke the GPU global synchronization level within a GPU kernel via a call to a sync( ) function, and can invoke a custom local synchronization level via a call to sync(local_sync_level). Note that the function call sync(local_sync_level) performs a GPU synchronization operation at the lower of local_sync_level (i.e., the local synchronization level) and the global synchronization level. Note also that a first synchronization level is considered to be “lower” than a second synchronization level if the first synchronization level has less GPU threads than the second synchronization level.

The GPU numerical system also implements a GPU local synchronization level that a GPU program can specify when running an operation or function implemented in the GPU numerical system. The GPU numerical system may run that operation at the local synchronization level or the global synchronization level, whichever is lower. The GPU local synchronization levels can include: an asynchronous mode (wherein all threads run the operation asynchronously), a warp-level synchronization mode (wherein the operation is synchronous relative to groups of 32 GPU threads), a thread-block-level synchronization mode (wherein the operation is synchronous within a respective GPU thread block), and a GPU-grid synchronization mode (wherein the operation runs at the current global synchronization level). A GPU kernel can configure its threads within a GPU thread block to run an operation of the GPU numerical system at the specified local synchronization level, if the specified local synchronization level is lower than the GPU global synchronization level. Hence, the global synchronization level may override the local synchronization level, which allows a code block within a GPU kernel to partition the GPU's compute resources into multiple groups of threads, and allows any operations within that code block to further partition the compute resources locally, without allowing for one group of threads to interfere with another group of threads.

For example, the GPU kernel can perform a memory allocation at a thread-block level of synchronization via a templated malloc operation using the following statement:

$$void ⋆ ptr = malloc < BLOCK\_SYNC > ( alloc\_size ) ,$$

which would cause a GPU thread block that performs the malloc operation to allocate a memory segment with a size given by ‘alloc_size’. In this example, all threads within a respective thread block would receive the same pointer to GPU global memory, and different thread blocks would receive a different pointer, because the “malloc<BLOCK_SYNC>( )” operation would perform a different memory allocation in GPU global memory for each GPU thread block that runs the command.

For example, the GPU numerical system may initiate a GPU kernel at a full GPU-grid level of synchronization. Then, a GPU program can configure a code block within the GPU kernel to run at a lower global synchronization level, such as at a GPU thread-block synchronization level, wherein the GPU numerical system can continue operating at this level of granularity until the end of the code block. Moreover, the code block may run functions whose operations further fragment the synchronization level to a finer local synchronization level, such as by performing asynchronous or warp-synchronous operations (where individual threads or individual GPU warps may follow a code path independent of other threads or warps, respectively). However, if a code block attempts to alter the global synchronization level to a higher synchronization level (e.g., from a GPU thread-block to a full GPU grid level), the GPU numerical system can set the runtime at the lower synchronization level of the two (e.g., leaving the synchronization level at the GPU thread-block level).

The GPU management framework can also manage memory allocation and deallocation at a local synchronization level provided for that operation by the GPU application (e.g., a GPU grid, a GPU thread block, a GPU warp, or a single-thread synchronization level), thereby providing flexibility in resource management. Additionally, the GPU management framework supports reduction operations that can consolidate values from individual threads to a given local synchronization level (e.g., across a GPU warp with 32 threads, a GPU thread block, or the full GPU grid). These reduction operations include arithmetic operations like addition and multiplication, as well as logical operations such as min, max, boolean OR/AND, and bitwise OR/AND. In these operations, if the GPU application requests to perform a synchronous operation at a local synchronization level that is different than the global synchronization level currently set for the GPU numerical system, the GPU numerical system may perform the operation at the lower of the two synchronization levels.

The matrix management framework facilitates efficient access to matrices or subsets of matrices at the local synchronization level selected by an application. It supports both asynchronous and synchronous cell access, where a synchronous cell access causes the GPU numerical system to retrieve a cell value that is synchronized at the current global GPU synchronization level, or an explicitly-selected local GPU synchronization level. This framework also enables access to a subset of a primary matrix (e.g., a matrix that accesses a complete numerical array), or a reference matrix (e.g., a secondary matrix that references at least a subset of a primary matrix), such as for a specific sets of rows, columns, or both, thereby enhancing the system's flexibility in handling large datasets.

The linear algebra library builds upon these frameworks to provide a wide range of operations, which include but are not limited to various linear algebra algorithms, time series computations, and statistical algorithms, which leverage the efficient matrix access and GPU resource management provided by the other components.

### GPU Matrix Data Structure

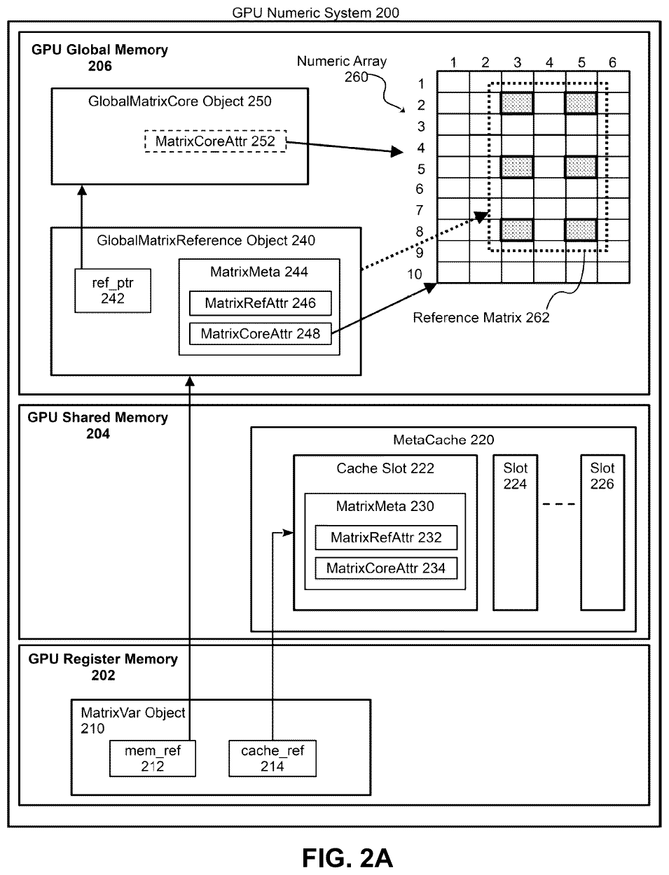

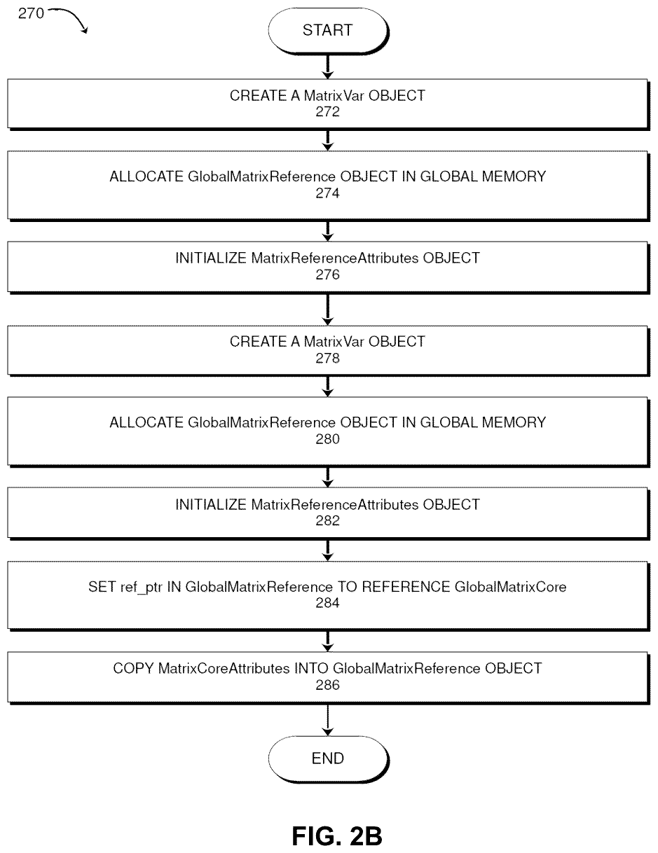

FIG. 2A illustrates an exemplary GPU numerical system 200 including both a GPU and data structures for managing a matrix variable's data and metadata of GPU numerical system 200 across the GPU's memory hierarchy in accordance with some embodiments described herein. As can be seen in FIG. 2A, GPU numerical system 200 can run on a GPU, such as a GPU that includes an architecture illustrated in FIG. 1A. The disclosed data structures used by system 200 can include a MatrixVar object 210 inside a register memory 202 of the GPU, wherein MatrixVar object 210 can represent a multi-dimensional matrix in a program. The disclosed data structures also include a GlobalMatrixReference object 240 inside a global memory 206 of the GPU that includes matrix metadata that references a numeric array 260 (or a subset of numeric array 260). Numeric array 260 represents a primary numeric array, which may operate as a data source for one or more reference matrices (e.g., reference matrix 262 accessed by MatrixVar object 210) that may be configured to access at least a subset of numeric array 260.

The disclosed data structures further include a GlobalMatrixCore object 250 (inside GPU global memory 206) that manages the memory allocation and deallocation for numeric array 260 in global memory 206 of the GPU. In some embodiments, GlobalMatrixCore object 250 may store a primary copy of metadata for the complete numeric array 260, which may be copied to one or more GlobalMatrixReference objects that reference at least a subset of numeric array 260. The disclosed data structures can also include a MetaCache 220 that resides in a shared memory 204 of the GPU, and may include a set of cache slots (e.g., cache slots 222, 224-226) to store a copy of the matrix metadata in shared memory 204 (e.g., to copy MatrixMeta object 244 from GlobalMatrixReference object 240 into cache slot 222 in MetaCache 220).

In some embodiments, the GPU numerical system may perform the operations on MatrixVar object 210, GlobalMatrixReference object 240, and/or GlobalMatrixCore object 250 at the global GPU synchronization level. In some alternative embodiments, a GPU program may explicitly provide a local synchronization level to an operation on the MatrixVar object, which configures the GPU numerical system to perform operations on the GlobalMatrixReference object 240 and/or the GlobalMatrixCore object 250 at the provided local synchronization level. Moreover, because MetaCache 220 resides in GPU shared memory 204, the GPU numerical system may perform operations on MetaCache 220 in a GPU thread-block synchronization level, or lower.

For example, numeric array 260 may be a 2-dimensional matrix, and GlobalMatrixCore object 250 may include a MatrixCoreAttributes 252 object that includes a shape vector with values {10, 6} that correspond to a shape with 10 rows and 6 columns for numeric array 260. GlobalMatrixReference object 240 may include a MatrixRefAttributes object 246 that includes various reference vectors, that together reference at least a subset of numeric array 260, such as the shaded blocks inside the dash-line box labelled as “reference matrix 262” in FIG. 2A. In this example, MatrixRefAttributes 246 includes a matrix-shape vector with values {3, 2} to give reference matrix 262 three rows and two columns, and an array-offset vector with values {2, 3} to clarify that reference matrix 262 begins at the second row and third column of numeric array 260. Moreover, reference matrix 262 can be a stride matrix. An array-stride vector in MatrixRefAttributes 246 has values {3, 2} to configure the row dimension to have a stride of three cells, and to configure the column dimension to have a stride of two cells. MatrixRefAttributes 246 can include an array-tile vector with values {1, 1} to configure reference matrix 262 to repeat each dimension once.

In some alternative embodiments, numeric array 260 may be allocated as a 2-dimensional sparse matrix, such as a sparse matrix implemented using a compressed sparse row (CSR) data structure. If MatrixCoreAttr 252 corresponds to a matrix with more than two dimensions, MatrixCoreAttr 252 may convert matrix indices from the higher dimension down to the two dimensions for the sparse matrix, prior to accessing the corresponding cell value from the CSR data structure for numeric array 260.

In some embodiments, MatrixVar object 210, which resides in GPU register memory 202, implements a light-weight data structure (e.g., by utilizing a small register-memory footprint) that leverages a GPU's shared memory 204 as much as possible to cache the matrix's metadata from GPU global memory 206. MatrixVar object 210 can perform efficient operations on numeric array 260 (or a subset thereof) by accessing the metadata information directly from MetaCache 220 in shared memory 204 instead of from GlobalMatrixReference object 240 in global memory 206, thereby avoiding the risk of a cache miss from the GPU's L1 or L2 cache.

As can be seen in FIG. 2A, MatrixVar object 210 can include two reference variables, and is designed to conserve space in GPU register memory 202:
a ‘mem_ref’ variable 212 configured to reference the matrix's metadata and core data in global memory 206; and
a ‘cache_ref’ variable 214 configured to reference a copy of the matrix's MatrixMeta object in GPU shared memory 204 (e.g., MatrixMeta 230), when possible.

The disclosed lightweight MatrixVar object 210 is designed to conserve space in GPU register memory 202 as much as possible to prevent a compiler from spilling “local memory” variables into the global memory when a GPU kernel or device function runs out of register memory space. To do so, the GPU numerical system may utilize GPU shared memory 204 to cache the metadata associated with the matrix of MatrixVar object 210, because the throughput of shared memory 204 can be 10× faster than that of global memory 206. Generally, a GPU SM block can dispatch one or more thread blocks, wherein threads within an individual GPU SM block can access their respective shared memory without interfering with other GPU SM blocks accessing their shared memory. For example, a GPU that dispatches 80 GPU thread blocks can allow those 80 GPU thread blocks to access their respective shared memory in parallel, if necessary, whereas only 4 of the 80 GPU thread blocks can access their metadata or data in the associated global memory in parallel (e.g., a conventional GPU oftentimes allows up to 4 simultaneous memory transactions to the global memory, creating an additional performance bottleneck between GPU thread blocks).

In some embodiments, the GPU numerical system may utilize GPU global memory 206 for long-term storage, wherein data can persist across GPU kernel invocations. For example, MatrixVar object 210 may store a matrix's metadata in the form of a dual-metadata-layer structure in global memory 206, to allow other matrices to reference a subset of the matrix. The dual-metadata-layer structure can include:
MatrixCoreAttributes 252 (or “MatrixCoreAttr 252”), which further includes at least a shape vector to describe the shape of the entirety of numeric array 260 (e.g., a size of each dimension for a multi-dimensional array 260), and a reference pointer to numeric array 260. Moreover, MatrixCoreAttributes 252 can also include metadata for the contents of numeric array 260 or can alternatively include a pointer to the array-contents metadata resided in GPU global memory 206. The metadata can include but are not limited to a matrix-shape vector to specify a number of cells to include for a corresponding dimension of numeric array 260, row indices (e.g., numeric indices, or DateTime information across matrix rows), timeframe information, column name data, and a matrix name; and
MatrixRefAttributes 246 (or “MatrixRefAttr 246”), which further includes at least metadata indicating which subset of the numeric array is being referenced. The metadata in MatrixRefAttributes 246 can include, for example, N-length vectors that identify at least a subset of an N-th dimensional array. The metadata in MatrixRefAttributes 246 can include an array-offset vector to specify a starting index for each dimension of the N-th dimensional array, and a matrix-shape vector to specify a number of cells to include for a corresponding dimension of reference matrix 262. The metadata in MatrixRefAttributes 246 can also include an array-stride vector to identify, for each dimension of the N-th dimensional array, a number of cells of the core numeric array to skip between cells of the reference N-th dimensional array. The metadata can also include an array-tile vector to indicate a number of times to tile (e.g., repeat) the numeric array along a respective dimension. MatrixRefAttributes 246 can also include other metadata, such as a transpose flag to indicate whether a matrix is to be accessed in a transposed manner, and/or can include temporary flags that facilitate processing a numeric array at runtime.

In some embodiments, MatrixVar object 210 and GlobalMatrixReference object 240 collectively implement a reference matrix of the disclosed GPU numerical system, which is configured to reference at least a portion of numeric array 260 using one or more vectors from MatrixRefAttributes 246. An application can use this reference matrix to reference at least a subset of a second matrix without having to perform a deep copy of the second matrix. Moreover, MatrixVar object 210 can correspond to a data type (e.g., a C++ class) that includes a multitude of device-side functions (e.g., GPU functions) that operate on the reference matrix in GPU global memory 206. The application can call these device-side functions from within a GPU kernel to implement complex computations on one or more matrices. For example, a respective function of MatrixVar object 210 may perform an element-wise operation, row-wise operation, column-wise operation, or cross-product operation on at least one reference matrix. As another example, MatrixVar object 210 may include one or more functions that perform mathematical, linear algebra, and/or statistical computations on at least one reference matrix. Furthermore, MatrixVar object 210 may include one or more functions that perform time-series computations on at least one reference matrix.

In some embodiments, a respective function of MatrixVar object 210 may allow a program to access a cell from the subset of the second matrix, based on a set of cell indices relative to the matrix shape for MatrixVar object 210. This function may allow the application to use MatrixVar object 210 as an abstraction of the computations necessary to access the subset of the second matrix.

In some embodiments, setting the array-offset, array-stride, and array-tile vectors in MatrixRefAttributes 246 to default values (e.g., {1, 1} vector values) configures the reference matrix to span the complete numeric array 260 referenced by MatrixCoreAttributes 248. Note that setting the array-offset vector elements to values greater than 1, or setting the matrix-shape vector elements to values less than the shape vector in MatrixCoreAttributes 248 would configure the reference matrix to select a matrix block that is a subset of numeric array 260 (e.g., a subset of rows, and/or a subset of columns of numeric array 260). Setting a dimension of the array-stride vector to a positive value “S” greater than 1 can configure that dimension of the reference matrix to skip (S−1) cells in the positive direction. Alternatively, setting a dimension of the array-stride vector to negative one (−1) configures that dimension of the reference matrix to be accessed in the negative direction, while setting a dimension of the array-stride vector to a negative value S less than −1 configures that dimension of the reference matrix to be accessed in the negative direction with a stride that skips (|S|−1) cells in the negative direction.

### Full-Array MatrixVar Objects

In some embodiments, the GPU numerical system can implement a version of MatrixVar object 210 that configures MatrixRefAttributes 246 to reference the full numeric array 260 without performing additional sub-matrix accessing operations that would convert matrix coordinates passed to MatrixVar object 210 (e.g., coordinates relative to reference matrix 262) to the full-matrix coordinates associated with numerical array 260. In this embodiment, the GPU numerical system uses the matrix index vector itself to access numeric array 260 by computing a row-major index value (or in some other embodiments, a column-major index value) that corresponds to the desired cell in numeric array 260, without first mapping the matrix index vector to another index vector that corresponds to the shape of numeric array 260. This embodiment of MatrixVar object 210 allows a program to perform efficient matrix-access operations when an application configures a reference matrix's MatrixVar object 210 to reference a contiguous block of numeric array 260 (e.g., to reference a contiguous set or subset of rows in numeric array 260 when numeric array 260 implements a row-major matrix, or to reference a contiguous set or subset of columns in numeric array 260 when numeric array 260 implements a column-major matrix).

In some further embodiments, if a program attempts to assign a second reference matrix to MatrixVar object 210, wherein the second reference matrix's MatrixRefAttributes object 246 does not have default vector values (e.g., corresponds to a sub-matrix) and MatrixVar object 210 is of a matrix data type whose mode of operation does not allow referencing a sub-matrix, the GPU numeric system may perform a deep copy operation from the second reference matrix onto a new GlobalMatrixReference object for MatrixVar object 210, to abide by MatrixVar object's mode of operation. In some alternative embodiments, if the program attempts to assign a third reference matrix to this MatrixVar object 210 where the third reference matrix's MatrixRefAttributes object 246 does have default vector values (e.g., references a full numeric array), the GPU numeric system is allowed to perform a shallow-copy operation from the third reference matrix's GlobalMatrixReference object to this MatrixVar object's associated GlobalMatrixReference object, without having to copy the referenced numeric array as well. In some embodiments, the GPU numerical system may perform the deep-copy or shallow-copy operation of a MatrixVar object at the global GPU synchronization level.

### Dual Matrix-Metadata Layers

Note that storing the attributes of the core matrix that holds the underlying numerical data (e.g., numeric array 260) and the attributes of the reference matrix that indicates how to access the underlying numerical data (e.g., reference matrix 262) as two separate objects (e.g., using MatrixCoreAttributes object 248 and MatrixRefAttributes object 246, respectively) in a MatrixMeta object (e.g., MatrixMeta object 244) provides several optimization benefits to the GPU numerical system. One benefit is that the MatrixCoreAttributes and/or the MatrixRefAttributes objects can each have member functions that are optimized for data locality of its own data elements, which are independent of the other objects. For example, the smaller contiguous memory footprint for the individual MatrixCoreAttributes object and/or the MatrixRefAttributes object provides a data locality that allows operations on those objects to achieve better memory access patterns.

Moreover, storing the MatrixCoreAttributes and the MatrixRefAttributes together within MatrixMeta object 244 (or “MatrixMeta 244”) also allows the GPU numerical system to better optimize MatrixMeta member functions that operate on both the MatrixCoreAttributes and the MatrixRefAttributes objects than would be possible if the MatrixCoreAttributes and the MatrixRefAttributes were stored as separate objects without a contiguous and/or fixed relative positioning to each other. This improvement is at least partially due to the fact that the L1 and L2 cache lines in a GPU are typically 128 bytes (e.g., a GPU from Nvidia™ Corporation), and the GPU's global memory subsystem fetches memory in the same size of 128 bytes to match the cache lines. Then, if a thread from the GPU numerical system encounters a cache miss at the L1 or L2 cache levels while accessing a single byte from GPU global memory 206, the memory subsystem fetches the entire corresponding 128-bytes from global memory and into the L2 and/or L1 caches.

Hence, MatrixMeta object 244 provides a data locality configuration for the dual metadata layers (e.g., MatrixRefAttr 246 and MatrixCoreAttributes 248) in GPU global memory 206, that configures the GPU to read the full MatrixMeta object 244 into L2 and/or L1 cache when a single thread reads a single element of the object and encounters a cache miss. Then, when the same GPU thread or another thread accesses another element of the respective MatrixMeta object 244, the GPU can perform that read operation from the L1 or L2 cache and not directly from the GPU's global memory 206 (which would be slower than reading from the L1 or L2 cache).

MatrixMeta object 244's data locality configuration for the dual metadata layers is also beneficial because this data locality can reduce or avoid bank conflicts in the GPU's shared memory. This is at least partially because the GPU's shared memory (in a respective GPU's SM block) can have 32 memory banks that are optimized for accessing contiguous memory locations in parallel. This means that 32 parallel read or write operations are allowed to that shared memory if those memory access operations are to different memory banks. Note that the data locality configuration of MatrixMeta object 244 helps avoid memory bank conflicts in the GPU shared memory by placing a reference matrix's metadata in memory locations so that one GPU shared memory bank would not need to access two memory locations of the same MatrixMeta object (e.g., if the MatrixMeta object is at most 128 bytes, such as for a matrix with 1 to 4 dimensions). If a MatrixMeta object consumes more than 128 bytes (e.g., a matrix has more than 4 dimensions), the individual MatrixCoreAttributes and the MatrixRefAttributes objects would themselves occupy less than 128 bytes (e.g., by limiting the number of matrix dimensions to at most 8 dimensions), and so operations on each of their contiguous memory spaces would not incur a bank conflict when accessing the respective MatrixCoreAttribute object or the MatrixRefAttributes object from the GPU shared memory.

For example, the data structure of MatrixMeta object 244 (or “MatrixMeta data structure”) serves to optimize the memory access patterns for a MatrixMeta member function that converts an index of each dimension of a multi-dimensional numeric array into a pointer to the corresponding cell of the numeric array, based on values in both the MatrixCoreAttributes object 248 (which is a copy of MatrixCoreAttributes 252) and the MatrixRefAttributes object 246. This optimization is possible because the MatrixMeta data structure can configure the GPU to better minimize the number of memory access operations to the GPU's global memory by leveraging the L1 and/or the L2 cache, and/or can configure the GPU to better minimize or avoid bank conflicts in the GPU's shared memory locations.

### ShapeVector Objects

Furthermore, the MatrixCoreAttributes objects 248 and 252, and the MatrixRefAttributes object 246, store their various vectors as individual vector objects (hereinafter referred to as a “ShapeVector” object, not shown in FIG. 2A), wherein a respective ShapeVector object stores its corresponding dimension information in a contiguous block of memory, and can include member functions that optimize the operations and GPU memory access patterns on a ShapeVector object. In some embodiments, the GPU numerical system may perform the ShapeVector operations (e.g., getter, setter, and/or computation operations) as asynchronous operations (e.g., as single-thread operations), to allow individual threads to process matrix cells independent of other GPU threads.

In some embodiments, a MatrixMeta object 244 can use these element-wise ShapeVector member functions to convert a reference index vector for a reference matrix (e.g., a MatrixVar object 210) into a core index vector for numeric array 260, based on the various metadata vectors of the matrix stored in MatrixRefAttributes 246. Then, the GPU numerical system may convert this core index vector into a scalar index value that can be used to access a corresponding cell in numeric array 260, for example, by using a ShapeVector member function that converts the core index vector into a scalar index value (e.g., a row-major or a column-major index value). The GPU numerical system can compute this scalar index value based on the index vector for the numeric array 260 and a matrix-shape vector that represents the dimensions for the full numeric array 260 (e.g., based on the matrix-shape vector in MatrixCoreAttributes 248). The GPU numerical system can then use this scalar index value to access the corresponding cell in numeric array 260.

### Managing Dual Metadata Layers (Allocating, Reference Counting, and Data Coherency)

In some embodiments, the GPU numerical system can store MatrixRefAttributes 246 and MatrixCoreAttributes 248 in a GlobalMatrixReference object 240, which itself includes a reference counter indicating the number of MatrixVar objects that are referencing GlobalMatrixReference object 240. For example, GlobalMatrixReference object 240 can include a MatrixMeta 244, that itself stores MatrixRefAttributes 246 and MatrixCoreAttributes 248.

Moreover, the GPU numerical system can store MatrixCoreAttributes 252 in a dedicated GlobalMatrixCore object 250, which itself includes a reference counter indicating the number of references to numeric array 260. MatrixCoreAttributes 248 in GlobalMatrixReference object 240 can be a cached copy of MatrixCoreAttributes 252 in GlobalMatrixCore object 250.

The GPU numerical system can decrement a reference counter in GlobalMatrixReference object 240 when a MatrixVar object that references it (e.g., MatrixVar object 210) is to be deallocated (e.g., by running an associated destructor function). If the reference counter in GlobalMatrixReference object 240 drops down to zero, the GPU numerical system can decrement a reference counter in GlobalMatrixCore object 250, and deallocate GlobalMatrixReference object 240. Moreover, if the reference counter in GlobalMatrixCore object 250 drops down to zero, the GPU numerical system can deallocate GlobalMatrixCore object 250, as well as numeric array 260.

FIG. 2B illustrates a process 270 for creating and initializing a MatrixVar matrix variable in accordance with some embodiments described herein. In one or more embodiments, one or more of the steps in FIG. 2B may be omitted, repeated, and/or performed in a different order. Accordingly, the specific arrangement of steps shown in FIG. 2B should not be construed as limiting the scope of the technique. Moreover, in some embodiments, the GPU numerical system may perform process 270 at the global GPU synchronization level, thereby causing the GPU numerical system to create and initialize a MatrixVar object at a synchronization level that has been configured by a GPU application at runtime (e.g., within a GPU kernel).

The disclosed GPU numerical system can create a MatrixVar object 210 for a new reference matrix (operation 272), such as in GPU register memory 202 (as illustrated in FIG. 2A), or alternatively in GPU shared memory 204 or GPU global memory 206 (not shown). The GPU numerical system can then allocate GlobalMatrixReference object 240 in GPU global memory 206 for the new reference matrix (operation 274), and subsequently initialize GlobalMatrixReference object 240 (operation 276). The GPU numerical system also sets mem_ref pointer 212 in MatrixVar object 210 so that it references GlobalMatrixReference object 240 in GPU global memory 206 (operation 278).

During operation 274, the GPU numerical system may initialize GlobalMatrixReference object 240 either as an empty matrix that has not yet been allocated, or it may allocate a new numeric array 260 for MatrixVar object 210. If the GPU numerical system is to allocate a new numeric array 260, the system allocates GlobalMatrixCore object 250 (operation 280), and initializes MatrixCoreAttr 252 with metadata for the new numeric array 260 (operation 282).

The GPU numerical system may then initialize GlobalMatrixReference object 240 with a pointer to numeric array 260 (operation 284), and may copy MarixCoreAttr 252 from GlobalMatrixCore object 250 onto MatrixCoreAttr 248 in GlobalMatrixReference object 240 (operation 286) to copy metadata information for the new reference matrix. In some embodiments, the GPU numerical system may perform operation 286 at the global GPU synchronization level, allowing the GPU numerical system to perform the copy operation in one coalesced memory transaction (because MatrixCoreAttributes object is typically of 128 bytes or less).

Reference matrices that do not reference a numeric array (e.g., an empty matrix) can serve as placeholder variables that would receive a reference to another matrix at a later portion of a program execution. The GPU numerical system can create the reference matrix by allocating MatrixVar object 210 in the GPU's register memory 202 (or alternatively, in shared memory 204 or global memory 206), and allocating a GlobalMatrixReference object 240 in global memory 206. The GPU numerical system may then initialize at least MatrixRefAttributes 246 to specify the reference matrix attributes, and may set a reference to GlobalMatrixReference object 240 in mem_ref 212 of MatrixVar 210.

In some embodiments, the disclosed GPU numerical system can allocate, in global memory 206, a numeric array for the reference matrix, which may involve allocating a new instance of GlobalMatrixCore object 250 and a new instance of numeric array 260 in global memory 206. The GPU numerical system may initialize a new instance of MatrixCoreAttributes object 252 to include a reference to numeric array 260 and/or to include matrix metadata that includes at least a matrix-shape vector that specifies the dimensions for numeric array 260. The GPU numerical system may then store a reference to GlobalMatrixCore object 250 in ref_ptr 242 of GlobalMatrixReference object 240. Moreover, the GPU numerical system may store a copy of MatrixCoreAttributes 252 into MatrixCoreAttributes object 248 in MatrixMeta object 244 in global memory 206.

Storing MatrixCoreAttributes 252 as a primary copy in GlobalMatrixCore object 250 allows an application's GPU kernel to edit MatrixCoreAttributes 252 at runtime, wherein the GPU numerical system can then copy the edited MatrixCoreAttributes 252 onto one or more GlobalMatrixReference objects that are referencing GlobalMatrixCore object 250. Hence, GlobalMatrixCore object 250 and GlobalMatrixReference object 240 may both store the same pointer to numeric array 260, which may be a one-dimensional array, a two-dimensional matrix, a three-dimensional matrix, or may be a matrix with four or more dimensions. GlobalMatrixReference object 240 can use MatrixMeta object 244 to store MatrixRefAttributes 246 for the reference matrix, and to store MatrixCoreAttributes 248 so that it mirrors a primary copy of MatrixCoreAttributes 252 in the matrix's GlobalMatrixCore object 250.

In some embodiments, the GPU numerical system can keep MatrixCoreAttributes 248 (in GlobalMatrixReference object 240) up to date with MatrixCoreAttribute 252 (in GlobalMatrixCore 250), whenever the user's program updates a matrix's MatrixCoreAttributes 252 via another MatrixVar object that also references that matrix's GlobalMatrixCore object 250. For example, GlobalMatrixCore 250 can store a reverse index of GlobalMatrixReference objects 240 whose ref_ptr 242 variables reference GlobalMatrixCore 250. Then, when the GPU numerical system updates MatrixCoreAttributes 252 for MatrixVar object 210, the GPU numerical system may invoke an update operation for the various GlobalMatrixReference objects stored in a reverse index in GlobalMatrixCore object 250, which allows the GPU numerical system to update the corresponding various MatrixCoreAttributes 248 to store a fresh copy of MatrixCoreAttributes 252.

### MetaCache

In some embodiments, the GPU numerical system stores GlobalMatrixCore 250 and GlobalMatrixReference 240 primarily in global memory 206. However, global memory 206 can be considerably slow to access. To mitigate this slow access, the GPU numerical system may also automatically store a copy of MatrixMeta object 244 (in GlobalMatrixReference object 240) into shared memory 204 at runtime, to ensure an application is not slowed down by a GPU's slower global-memory transactions. This will significantly speed up the access to numeric array 260, because the GPU numerical system can obtain the matrix metadata for MatrixVar object 210 (e.g., the pointer to numeric array 260 and its matrix attributes) from MatrixCoreAttributes 234 in shared memory 204, thereby avoiding having to access the pointer to numeric array 260 from MatrixCoreAttributes 248 in the GPU's global memory 206. Moreover, accessing a cell in a matrix may oftentimes require converting a set of matrix cell coordinates (e.g., row index and column index) into an array index for numeric array 260, which would also require reading numerous matrix attributes from a MatrixCoreAttributes object and numerous attributes from a corresponding MatrixRefAttributes object. Hence, accessing these attributes from shared memory 204 (e.g., via MatrixCoreAttributes 234 and MatrixRefAttributes 232) to compute the array index for numeric array 260 would be significantly faster than accessing these attributes from global memory 206 (e.g., via MatrixRefAttributes 246, and either MatrixCoreAttributes 248 or MatrixCoreAttributes 252).

In some embodiments, numeric array 260 may have at most four dimensions. An application can, for example, use these four dimensions to model multiple data points in three spatial dimensions (e.g., using Cartesian coordinates x, y, z to model electromagnetic field values in space), and using a fourth dimension (e.g., a “column” dimension) to represent various data sets (e.g., a column for electric field values, and a column for magnetic field values). MatrixMeta object 244 with at most 4 dimensions may have a memory size of up to 128 bytes. The GPU numerical system may allocate GlobalMatrixReference object 240 with a memory boundary offset that is selected to ensure the associated MatrixMeta object 244 resides between two neighboring 128-byte memory boundaries in global memory 206. This configuration that stores up to 128 bytes between two neighboring 128-byte memory boundaries in global memory 206 facilitates a read or write memory access in one coalesced 128-byte global-memory transaction. This enables the GPU numerical system to efficiently copy MatrixMeta object 244 from global memory 206 to shared memory 204, by copying the matrix's dual-metadata-layer structure (e.g., the MatrixMeta object 244) in one coalesced 128-byte memory transaction, into a pre-reserved MatrixMeta slot in the shared memory.

In some alternative embodiments, numeric array 260 may have more than four dimensions. For example, an application can use more than four dimensions to model a plasma flow via three spatial dimensions (with Cartesian coordinates x, y, z), two or more velocity dimensions, and an additional dimension for various physical properties. MatrixMeta object 244 with at most 8 dimensions may have a memory size of up to 256 bytes. The GPU numerical system may allocate GlobalMatrixReference object 240 with a memory boundary offset that is selected to ensure the associated MatrixMeta object 244 crosses at most one 128-byte memory boundary in global memory 206. This configuration facilitates a read or write memory access in two coalesced 128-byte global-memory transactions, such as when storing a copy of MatrixMeta object 244 into MetaCache object 220 in shared memory 204. Caching a 256-byte MatrixMeta object 244 in two coalesced memory transactions is considerably faster than copying MatrixCoreAttributes 252 and MatrixRefAttributes 246 onto MetaCache object 220 in shared memory 204 in 4 or more separate un-aligned transactions from global-memory 206.

In some embodiments, the disclosed GPU numerical system uses MetaCache object 220 to pre-allocate and manage cache slots in a GPU thread block's shared memory 204. Note that MetaCache object 220 includes cache slots 222-226, wherein a respective cache slot is sufficiently large to hold a MatrixMeta object, or other metadata objects for various other types of data structures. MetaCache object 220 can manage its data structures in GPU shared memory at the GPU thread-block level or at the single-thread level of synchronization, even when the overall GPU numerical system is configured for full GPU-grid synchronization. This design ensures that each thread block can efficiently manage its own MetaCache object, thereby allowing for localized optimization of matrix metadata access regardless of the global synchronization settings. For example, if the GPU numerical system operating in a full GPU-grid synchronization level or a thread-block synchronization level, the system may copy a MatrixMeta block from a GlobalMatrixRefernce object into a cache slot in a MatrixMeta object in one coalesced memory transaction (if the MatrixMeta object is 128 bytes or less) or two coalesced memory transactions (if the MatrixMeta object is 256 bytes or less).

Alternatively, the GPU numerical system may copy the MatrixMeta block from the GlobalMatrixRefernce object into the cache slot in the MatrixMeta object using a single thread, which may still benefit from coalesced memory transactions from GPU global memory if the GPU caches the MatrixMeta object in an L1 or L2 cache layer. However, in the single-thread synchronization level, the single thread would need to copy the individual 4-byte words from the L1 or L2 cache layer into the MatrixMeta object in a sequence of memory transactions.

Once the GPU numerical system has uploaded a MatrixVar object's metadata into a cache slot in the MetaCache object, the GPU numerical system may access that cached metadata in either a synchronous (GPU thread-block synchronization) or asynchronous (single-thread synchronization) mode of operation.

Individual GPU thread blocks of the GPU numerical system can allocate a MetaCache object 220 in their respective shared memory (e.g., FIG. 1A illustrates how SM-1 block includes a dedicated L1 cache and a dedicated shared memory separated from other SM blocks in a GPU). Hence, MetaCache object 220 for one GPU thread block can operate independently from another MetaCache object stored at another dedicated shared memory for a different GPU thread block. When the GPU numerical system attempts to access a matrix's metadata, it can first determine if cache_ref variable 214 (or “cache_ref 214”) has a valid reference value (e.g., a non-nil value, or a non-zero value). For example, the reference value may be a pointer value, that directly references a memory address for MetaCache slot 222. Alternatively, the reference value may be an index value, which specifies an entry number within MetaCache object 220 (e.g., wherein a ‘nil’ index value may be encoded as a negative value, or 0 (zero), to indicate a non-reference, and wherein numeric (e.g., integer) values above the “nil” index value indicate a reference to a valid cache slot in MetaCache object 220).

If cache_ref variable 214 holds a valid reference value, the GPU numerical system can use that reference value to access the MatrixMeta metadata from the shared memory slot (e.g., slot 222) in MetaCache object 220. However, if cache_ref 214 has a nil value, the GPU numerical system can attempt to reserve a cache slot for MatrixMeta object 244. If a cache slot is available in shared memory 204, the GPU numerical system may copy MatrixMeta object 244 from GlobalMatrixReference object 240 into the reserved cache slot (e.g., slot 222) in MetaCache object 220 in one coalesced memory transaction (e.g., for matrices of up to 4 dimensions) or two coalesced memory transactions (e.g., for matrices with more than 4 dimensions).

In some embodiments, if MetaCache 220 does not have an unused cache slot, the GPU numerical system can evict a cache entry that has been accessed the least recent (e.g., a least-recently-used cache slot). To evict a cache slot, the GPU numerical system may use a reverse pointer in MetaCache 220 to locate an MatrixVar object that is currently occupying the slot, and the GPU numerical system may then set cache_ref 214 in that MatrixVar object to a nil index value. Alternatively, if the GPU numerical system detects that MetaCache 220 does not have an unused cache, the GPU numerical system may access MatrixMeta object 244 for MatrixVar object 210 from the global memory (e.g., from GlobalMatrixReference object 240).

In some embodiments, MetaCache object 220 accesses and/or maintains its various cache slots using a multithreaded operation within a GPU thread block (e.g., to reserve, release, copy data to or from a cache slot). The GPU numerical system may can pre-allocate a number of cache slots in MetaCache object 220 that is less than or equal to the number of threads that the GPU numerical system may use to access and/or maintain the various cache slots. For example, the GPU numerical system may allocate up to 32 slots to be managed by 32 execution threads per GPU thread block (e.g., the length of one CUDA warp), so that MetaCache 220 may search for a cache slot in one concurrent multithreaded operation (e.g., to search for an empty cache slot, search for a least-recently-used cache slot, or search for a slot that includes a given pointer value).

In some alternative embodiments, the GPU numerical system may configure a program to utilize: 128 execution threads per GPU thread block, 256 execution threads per GPU thread block, 512 execution threads per GPU thread block, or 1024 execution threads per GPU thread block. The GPU numerical system may pre-allocate a number of entries inside MetaCache 220 that is less than or equal to the pre-allocated execution threads in the GPU thread block, so that the GPU thread block may access and/or maintain its various cache slots concurrently (e.g., without requiring multiple loop iterations). In some alternative embodiments, MetaCache 220 may pre-allocate a number of entries inside MetaCache 220 that is greater than the number of available execution threads per GPU thread block, and may configure the threads in the GPU thread block to iterate across the cache slots when searching for an existing entry or for an empty cache slot.

For example, if a program performs a multi-threaded operation on MatrixVar object 210 whose cache_ref variable 214 has a nil value, the GPU numerical system can efficiently search for a cache slot to reserve in one multi-threaded memory-transaction operation, and can copy MatrixMeta object 244 from the global memory to the reserved cache slot (e.g., slot 222) in MetaCache object 220 in one coalesced memory transaction. Thereafter, if the program performs another single-threaded or multi-threaded operation on the same MatrixVar object 210, MatrixVar object 210 will be able to access the metadata directly from the reserved cache slot (e.g., slot 222) in shared memory 204 via the non-nil reference value in cache_ref variable 214.

However, if a program performs a single-threaded operation on MatrixVar object 210, and if cache_ref variable 214 in MatrixVar object 210 has a nil value, then the GPU numerical system may use mem_ref variable 212 to access MatrixMeta object 244 directly from GlobalMatrixReference object 240 in global memory 206, without configuring MetaCache object 220 to search for an unused cache entry.

In some alternative embodiments, the GPU numerical system may configure MetaCache object 220 to search for an unused cache slot using a single-threaded operation, and to copy MatrixMeta 244 from global memory 206 to the reserved cache slot via a sequence of single-threaded copy operations. The single-threaded copy operations may benefit from the memory placement of MatrixMeta object 244 between two neighboring 128-byte memory boundaries in the global memory 206, because the GPU may perform a complete 128-byte coalesced memory transaction from global memory 208 upon a cache miss (e.g., a cache miss in L1 or L2 cache), and may store the results of the 128-byte memory transaction in L2 cache, or in L1 cache (see FIG. 1A). The GPU may resolve subsequent single-threaded memory accesses to MatrixMeta 244 by reading the data from L2 cache or L1 cache. Hence, copying the MatrixMeta object via single-threaded copy operations may trigger one coalesced memory transaction from the GlobalMatrixReference in global memory to L2 cache or L1 cache, and then a plurality of single-threaded memory transactions may copy the remainder of the MatrixMeta object from L2 cache or L1 cache to shared memory 204 (e.g., to the reserved cache slot 222 in MetaCache object 220).

In some embodiments, GlobalMatrixReference object 240 and/or GlobalMatrixCore object 250 perform reference counting in order to keep track of the number of MatrixVar objects that are referencing them across one or more GPU thread blocks. The GPU numerical system may call a destructor for GlobalMatrixReference object 240 or GlobalMatrixCore object 250 when the associated reference count indicates that there is no MatrixVar object that is referencing object 240 or object 250. In some further variations, when an MatrixVar object that spans N GPU thread blocks connects to GlobalMatrixReference object 240 or to GlobalMatrixCore object 250, the reference count to that MatrixVar object increments by N, which would allow a respective MatrixVar object to disconnect separately from GlobalMatrixReference object 240 or GlobalMatrixCore object 250 if the program flow for the corresponding GPU thread block were to diverge to different code blocks (e.g., due to a branch in the program's execution).

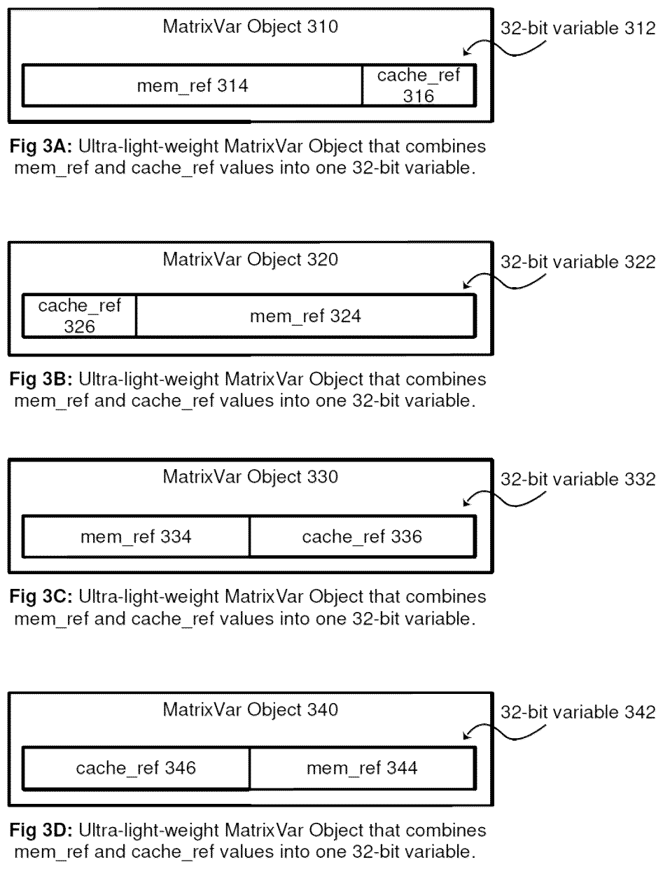

FIGS. 3A-3D illustrate various examples of an ultra-lightweight MatrixVar object that combines the mem_ref and cache_ref variable values into one variable for implementing MatrixVar object 210 in FIG. 2 in accordance with some embodiments described herein. In some embodiments, a respective MatrixVar object variation in FIGS. 3A-3D may occupy 32 bits (e.g., a 32-bit register in a GPU local memory, a GPU shared memory, or a GPU global memory). For example, the GPU numerical system may pre-allocate a pool of GlobalMatrixReference objects 240 in the global memory 206, and the GPU numerical system may instantiate a MatrixVar object based on any of the MatrixVar object variations in FIGS. 3A-3D), where the MatrixVar object may reserve an available GlobalMatrixReference object 240 from the global pool when instantiating a new matrix. The mem_ref variable of the MatrixVar object may specify an index or offset to a reservation in the pool of GlobalMatrixReference objects 240 (thus, in this embodiment, the mem_ref variable may not require a full 32-bit or 64-bit pointer to a GPU memory address space). Similarly, the cache_ref variable of the MatrixVar object may indicate an index or offset to a MetaCache slot in the shared memory (in this embodiment, the cache_ref variable also may not require a full 32-bit or 64-bit pointer to a GPU memory address space).

### Pre-Allocating Memory Pools for GlobalMatrixReference Objects

In some embodiments, the GPU numerical system may maintain an array of indices (e.g., an array of integers), wherein the array has the same number of entries as the number of pre-allocated GlobalMatrixReference objects 240. Each non-nil entry in the array of indices corresponds to a pre-allocated GlobalMatrixReference object that is available to be reserved. The GPU numerical system may set a cell of the index array to zero or NULL in response to checking out the index value in that cell for use by a MatrixVar object's mem_ref variable. The checked-out index value corresponds to a GlobalMatrixReference object 240 that MatrixVar has reserved for itself to instantiate a matrix. The GPU numerical system returns (e.g., recycles) the index value in the MatrixVar object's mem_ref variable to any empty slot in the array of indices when the MatrixVar object no longer needs the corresponding GlobalMatrixReference object 240 (e.g., when the MatrixVar object's destructor releases its resources before the corresponding memory deallocation).

As a further alternative, the GPU numerical system may pre-populate a subset of the array of pointers (e.g., by allocating a predetermined number of GlobalMatrixReference objects 240 in one contiguous block, and allocating the array of indices so that it has a significantly larger number of entries than the pre-allocated number of GlobalMatrixReference objects 240). Subsequently, the GPU numerical system may populate other pointer entries on-demand if the application requires utilizing more GlobalMatrixReference objects 240 than what are available from the pre-allocated block. Similarly, the MetaCache object 220 may pre-allocate a pool of MatrixMeta objects 230 (e.g., inside cache slots 222-226) as illustrated in FIG. 2.

### MatrixVar: Light-Weight Variable Objects

Specifically, FIG. 3A illustrates an exemplary ultra-lightweight MatrixVar object 310 that implements MatrixVar object 210 in FIG. 2 in accordance with some embodiments described herein. In these embodiments, MatrixVar object 310 may include a 32-bit variable 312 that uses 24 bits as a corresponding mem_ref variable 314 (to represent an index to a GlobalMatrixReference object 240 that MatrixVar object 310 has reserved from the global pool), and further uses 8 bits as a corresponding cache_ref variable 316 (to represent an index to a MatrixMeta slot that MatrixVar object 310 has reserved from the MetaCache pool in a shared memory). For example, mem_ref 314 may occupy the first 24 bits of 32-bit variable 312, and cache_ref 316 may occupy the last 8 bits of 32-bit variable 312.

FIG. 3B illustrates another exemplary ultra-lightweight MatrixVar object 320 that alternatively implements MatrixVar object 210 in FIG. 2 in accordance with some embodiments described herein. In these embodiments, MatrixVar object 320 may include a 32-bit variable 322, that may set its first 8 bits as the corresponding cache_ref variable 326, and may set the last 24 bits of variable 322 as the corresponding mem_ref variable 324.

FIG. 3C illustrates yet another exemplary ultra-lightweight MatrixVar object 330 that implements MatrixVar object 210 in FIG. 2 in accordance with some embodiments described herein. In these embodiments, MatrixVar object 330 may include a 32-bit variable that uses 16 bits as the corresponding mem_ref variable and the other 16 bits as the corresponding cache_ref variable. For example, MatrixVar object 330 may include a 32-bit variable 332, where mem_ref 334 may occupy the first 16 bits of variable 332, and cache_ref 336 may occupy the last 16 bits of variable 332.

FIG. 3D illustrates still another exemplary ultra-lightweight MatrixVar object 340 that implements MatrixVar object 210 in FIG. 2 in accordance with some embodiments described herein. In these embodiments, MatrixVar object 340 may include a 32-bit variable 342, where the corresponding cache_ref 346 may occupy the first 16 bits of variable 342, and the corresponding mem_ref 344 may occupy the last 16 bits of variable 342.

### Passing Matrices by Reference

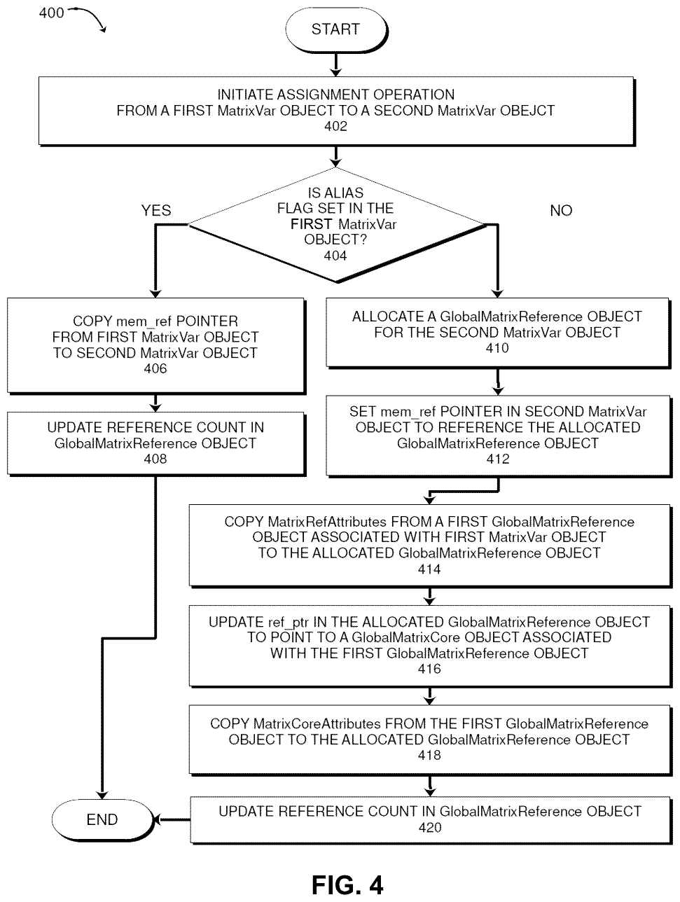

In some embodiments, the GPU numerical system operates to pass a MatrixVar matrix object by reference (e.g., during an assignment operation, a shallow MatrixVar copy constructor, or when the matrix is passed as a function argument), thereby avoiding a slow copy operation on the various matrix cells. FIG. 4 illustrates a process 400 for implementing a flexible assignment operation for MatrixVar objects, which supports both shallow copying and aliasing in accordance with some embodiments described herein. In one or more embodiments, one or more of the steps in FIG. 4 may be omitted, repeated, and/or performed in a different order. Accordingly, the specific arrangement of steps shown in FIG. 4 should not be construed as limiting the scope of the technique. Moreover, in some embodiments, the GPU numerical system may perform process 400 at the global GPU synchronization level, thereby causing the GPU numerical system to perform the assignment operation at a synchronization level that has been configured by a GPU application at runtime (e.g., within a GPU kernel).

To begin, the GPU numerical system may initiate an assignment operation from a first MatrixVar object to a second MatrixVar object (operation 402), which can be triggered by an assignment statement (e.g., “B=A”) or an aliasing operation (e.g., “B=A.alias( )”). The system then checks if an alias flag is set in the first MatrixVar object (operation 404). If the alias flag is set, the GPU numerical system proceeds with the aliasing process. Specifically, this aliasing process copies the mem_ref pointer from the first MatrixVar object to the second MatrixVar object (operation 406), causing both MatrixVar objects to reference the same GlobalMatrixReference. The aliasing process also updates the reference count in the GlobalMatrixReference object (operation 408) to reflect the new reference. The assignment operation may conclude after performing operations 406-408 for aliased objects.

If the alias flag is not set, the GPU numerical system may initiate a shallow copy process. Specifically, the shallow-copy process may allocate a new GlobalMatrixReference object for the second MatrixVar object (operation 410), and sets the mem_ref pointer in the second MatrixVar object to reference this newly allocated GlobalMatrixReference object (operation 412). In some embodiments, allocation step 410 may be implemented by selecting an unused GlobalMatrixReference object from a pool of pre-allocated GlobalMatrixRefrence objects.

Next, the GPU numerical system can copy the MatrixRefAttributes from the first GlobalMatrixReference object, which is associated with the first MatrixVar object, to the newly allocated GlobalMatrixReference object (operation 414). In some embodiments, the GPU numerical system may perform operation 414 while the GPU numerical system is configured to run in a full GPU-grid synchronization level or in a thread-block synchronization level, and performs the copy operation in one coalesced memory transaction (because MatrixRefAttributes object is 128 bytes or less).

The GPU numerical system also updates the ref_ptr in the allocated GlobalMatrixReference object to point to the GlobalMatrixCore object associated with the first GlobalMatrixReference object (operation 416). The system may also copy the MatrixCoreAttributes from the first GlobalMatrixReference object to the allocated GlobalMatrixReference object (operation 418). In some embodiments, the GPU numerical system may perform operation 418 while the GPU numerical system is configured to run in a full GPU-grid synchronization level or in a thread-block synchronization level, and performs the copy operation in one coalesced memory transaction (because MatrixCoreAttributes object is 128 bytes or less).

The system also updates the reference count in the GlobalMatrixReference object (operation 420) to reflect the new reference. The shallow-copy operation may conclude after performing operations 410-420 for non-aliased objects.

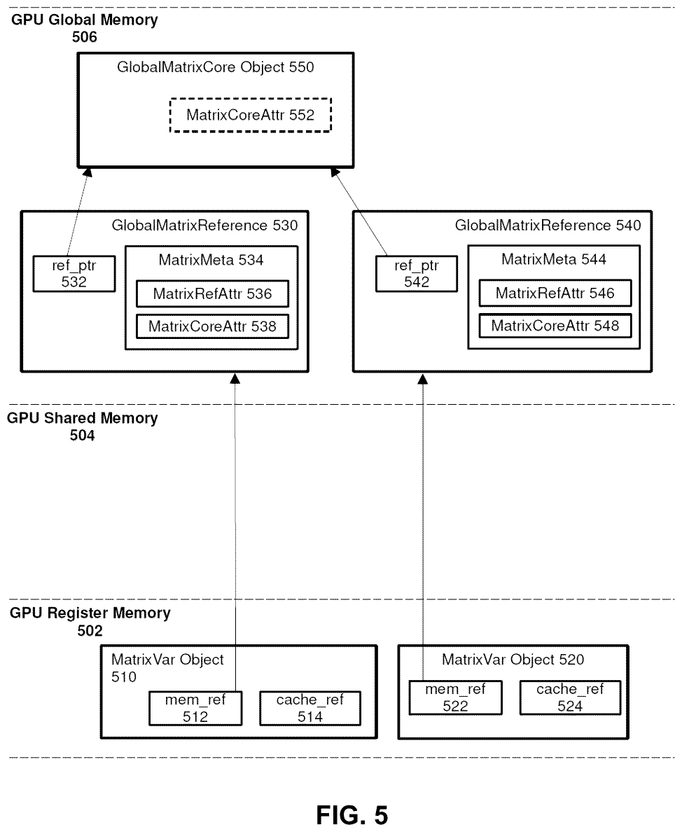

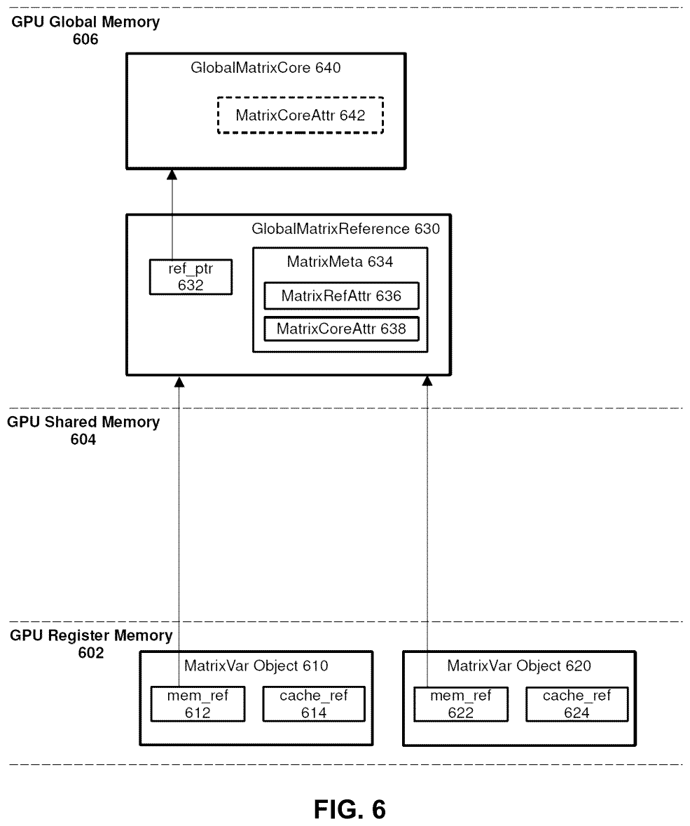

This above-described assignment process, as illustrated in FIG. 4, provides the foundation for the more detailed scenarios depicted in FIG. 5 and FIG. 6, and the associated description in the following paragraphs.

FIG. 5. illustrates two exemplary MatrixVar objects 510 and 520 (or simply “MatrixVar 510 and MatrixVar 520”) that reference the same or different portions of a numeric array in accordance with some embodiments described herein. Note that the same numeric array is also referenced by MatrixCoreAttributes 552 in GlobalMatrixCore object 550 in FIG. 5.

For example, MatrixVar 510 may be a matrix variable that references a numeric array corresponding to MatrixCoreAttributes 552 (via GlobalMatrixReference 530), and MatrixVar 520 may initially be an unallocated matrix variable (e.g., a new or existing variable associated with GlobalMatrixReference 540 whose ref_ptr 542 has a NULL value). Alternatively, MatrixVar 520 may initially be associated with another matrix (not shown). The GPU numerical system can implement an assignment operation on MatrixVar 520 (e.g., via an operation such as B=A) by performing a quick shallow-copy operation onto MatrixVar 520, thus avoiding a costly copy operation of the full matrix corresponding to MatrixVar 510. The shallow-copy operation may copy MatrixRefAttributes 536 within GlobalMatrixReference 530 to MatrixRefAttributes 546 within GlobalMatrixReference 540, and may update ref_ptr 542 within GlobalMatrixReference 540 so that it holds the pointer value from ref_ptr 532 within GlobalMatrixReference 530, thus causing MatrixVar matrix 520 to point to the same matrix region as MatrixVar 510. In some embodiments, the GPU numerical system may store a copy of MatrixCoreAttributes 552 into MatrixCoreAttributes 548 of GlobalMatrixReference 540 as a separate operation. Alternatively, the GPU numerical system may copy MatrixCoreAttributes 538 into MatrixCoreAttributes 548 during the same copy operation that copies MatrixRefAttributes 536 to MatrixRefAttributes 546 (e.g., in one coalesced memory read transaction from MatrixMeta 534, and one coalesced memory write transaction to MatrixMeta 544).

As another example, MatrixVar 520 may be a new or existing variable that is initialized to reference a portion of a matrix referenced by MatrixVar 510. This can be accomplished via a statement that references a portion of another matrix, such as using the following statement that references rows 3 to 10 from matrix A:

MatrixVar B=A·rows(3,10);

In this case, matrix A may first create a new GlobalMatrixReference object 530 for the sub-matrix, and then copy those matrix attributes to MatrixRefAttributes 546 (within GlobalMatrixReference 540). In other words, MatrixVar object 510 does not need to release (or deallocate) GlobalMatrixReference object 530 when performing a shallow-copy operation. This GPU numerical system configuration allows changes made by one GPU thread block onto GlobalMatrixReference object 530 to be visible by other GPU thread blocks (e.g., those GPU thread blocks that also reference the same corresponding MatrixVar object) when the program execution flow of various GPU thread blocks diverges to different blocks of code. In some embodiments, the GPU numerical system may access a sub-matrix in a two-step process, wherein the GPU numerical system may first copy a reference to GlobalMatrixCore 550 from ref_ptr 532, and onto the ref_ptr in a new temporary sub-matrix (e.g., which the GPU numerical system may create as a result of the A.rows(3,10) function call). The GPU numerical system would then copy this reference when performing the assignment operator from that temporary sub-matrix's GlobalMatrixReference object onto ref_ptr 542 of the target matrix's GlobalMatrixReference 540.

For example, the GPU numerical system may create a new MatrixVar object 520 for a reference matrix B within register memory 502, or possibly in shared memory 504 or in global memory 506, and may allocate a GlobalMatrixReference object 540 in global memory 506. The GPU numerical system may then perform the assignment operation onto reference matrix B by initializing MatrixRefAttributes 546 to hold a copy of MatrixRefAttributes 536 from the temporary reference matrix, and may copy the reference to GlobalMatrixCore 550 from ref_ptr 532 to ref_ptr 542 in GlobalMatrixReference 540 for the new sub-matrix.

In some embodiments, the reference to GlobalMatrixCore 550 can be first copied from ref_ptr 532 to the ref_ptr in the new sub-matrix, and then copied by the assignment operator from that sub-matrix's GlobalMatrixReference object onto ref_ptr 542 of GlobalMatrixReference 540.

In some embodiments, two different MatrixVar objects (e.g., MatrixVar 510 and MatrixVar 520) may alias each other, such that modifying reference attributes via one MatrixVar variable causes the other MatrixVar object to have access to those modifications. For example, FIG. 6 illustrates two exemplary MatrixVar objects 610 and 620 aliasing the same GlobalMatrixReference 630 in accordance with some embodiments described herein. This aliasing operation can be accomplished via an MatrixVar::alias( ) function that temporarily sets an alias flag in GlobalMatrixReference 630 or in a temporary rvalue-typed MatrixVar object, prior to performing the following assignment operation:

MatrixVar B=A·alias( ).

In the above example, variable A may correspond to MatrixVar object 610, and variable B may correspond to MatrixVar object 620. MatrixVar object 610 (e.g., variable A) may initially have mem_ref 612 with a value that references GlobalMatrixReference 630, whose ref_ptr 632 references GlobalMatrixCore 640. As mentioned earlier, the alias( ) function may set a temporary alias flag in GlobalMatrixReference 630, or in a new rvalue-typed MatrixVar object created by the A.alias( ) function. In either case, if an assignment operation on MatrixVar object 620 detects that the RHS (right-hand-side) variable has the alias flag set, the assignment operation may avoid performing a shallow-copy operation via GlobalMatrixReference 630, and instead may update mem_ref 622 in MatrixVar object 620 (e.g., variable B) so that mem_ref 622 holds the same reference value as mem_ref 612 of MatrixVar object 610 (e.g., RHS variable passed by A.alias( )).

For example, the GPU numerical system may create a new MatrixVar object 620 for reference matrix B (e.g., in register memory 602, or possibly in shared memory 604 or global memory 606). However, instead of allocating a new GlobalMatrixReference for MatrixVar 620, the GPU numerical system may instead copy a reference to GlobalMatrixReference 630 from mem_ref 612 of MatrixVar object 610 onto mem_ref 622 of MatrixVar object 620.

After the assignment operation, both mem_ref 612 of MatrixVar object 610 and mem_ref 622 of MatrixVar object 620 will both hold a reference to GlobalMatrixReference 630. Any modifications to matrix metadata associated with MatrixVar 610 (e.g., to MatrixRefAttributes 636, or to MatrixCoreAttributes 638) will also affect the matrix variable associated with MatrixVar object 620. This configuration can be useful when passing a matrix as a function argument, wherein the function is expected to modify a matrix's metadata (e.g., MatrixRefAttributes 636) and/or ref_ptr 632. When the MatrixVar object is passed as a function argument via the alias( ) operation, the operation causes the C++ runtime to perform an aliasing copy of the MatrixVar object to the function:

my_function(A·alias( ));

After my_function( ) completes, any updates to the metadata and reference variables (e.g., MatrixRefAttributes variable 636 and ref_ptr variable 632) of the corresponding GlobalMatrixReference object within the function ‘my_function( )’ can then be applied to the MatrixVar object for variable A, without having to pass variable A by reference.

### Alternative Memory Configurations

In some embodiments, the GPU numerical system may store the MatrixVar objects in the GPU's shared memory and/or in the GPU's global memory instead of in the register memory as described above, thereby conserving the limited number of register memory space available to each GPU core processor.

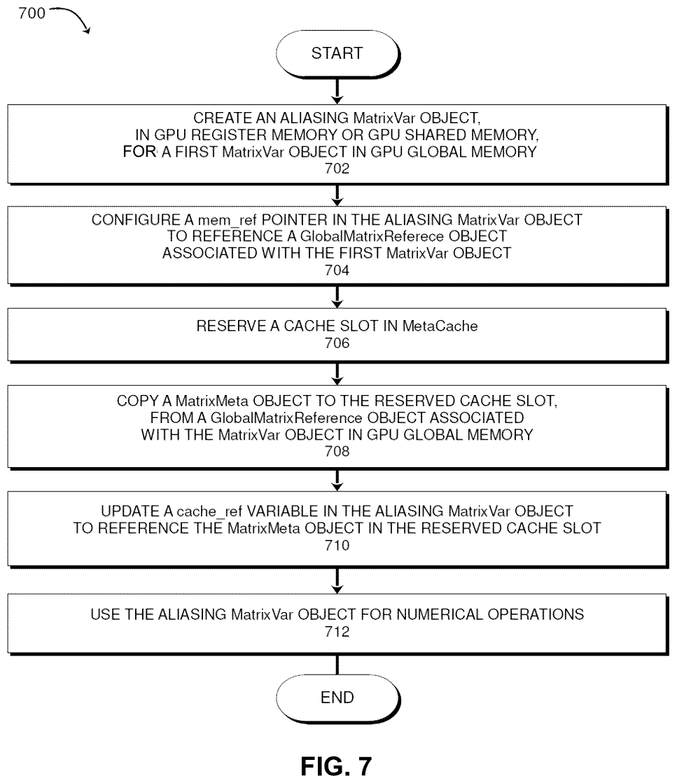

FIG. 7 illustrates a process 700 for caching a MatrixMeta metadata object in a GPU shared memory, for a MatrixVar object stored in a corresponding GPU global memory, in accordance with some embodiments described herein. In one or more embodiments, one or more of the steps in FIG. 7 may be omitted, repeated, and/or performed in a different order. Accordingly, the specific arrangement of steps shown in FIG. 7 should not be construed as limiting the scope of the technique. Moreover, in some embodiments, the GPU numerical system may perform the process 700 at the global GPU synchronization level. However, the GPU numerical system may operate on a MetaCache object at a GPU thread-block synchronization level or the global GPU synchronization level, whichever is lower, to enable a GPU thread block to manage its MetaCache object independent of other GPU thread blocks.

During operation, the GPU numerical system or a GPU program may need to optimize access to a MatrixVar object that resides in the GPU global memory, and to optimize access to its associated metadata as well. For this, the GPU numerical system can create an aliasing MatrixVar object either in the GPU register memory or the GPU shared memory, which aliases the MatrixVar object in the GPU global memory (operation 702). Because the new MatrixVar object is an aliasing MatrixVar object, the GPU numerical system can configure a mem_ref pointer in the newly created aliasing MatrixVar object to reference a GobalMatrixReference object associated with the MatrixVar object being aliased (operation 704). This configuration ensures that both MatrixVar objects point to the same underlying matrix metadata and numerical data.

The system can then reserve a cache slot in the MetaCache object (operation 706). This reservation prepares a space in the shared memory for storing frequently accessed metadata for the MatrixVar object. Once the GPU numerical system reserves the cache slot, the system copies a MatrixMeta object to this reserved cache slot from the GlobalMatrixReference object associated with the MatrixVar object in GPU global memory (operation 708). In some embodiments, the GPU numerical system may perform operation 708 while it is configured to run in a full GPU-grid synchronization level or in a thread-block synchronization level, and performs the copy operation in one coalesced memory transaction (if the MatrixMeta object is 128 bytes or less) or in two coalesced memory transactions (if the MatrixMeta object is 256 bytes or less). Alternatively, the GPU numerical system may perform operation 708 in a single-thread synchronization level, and may copy 4-byte segments of the MatrixMeta object sequentially.

The GPU numerical system also updates the cache_ref variable in the aliasing MatrixVar object to reference the MatrixMeta object in the reserved cache slot (operation 710), which allows a GPU program to access to the matrix metadata efficiently through GPU shared memory.

The GPU numerical system or the GPU program can then use the aliasing MatrixVar object for numerical operations (operation 712). By doing so, the GPU numerical system or GPU program accesses the matrix metadata via the MatrixVar object in the GPU register memory or the shared memory, and via the MetaCache entry in the shared memory, without having to access the MatrixVar object or its metadata objects (e.g., GlobalMatrixReference object or the GlobalMatrixCore object) in GPU global memory.

We now describe detailed examples of the optimization process described in conjunction with FIG. 7.

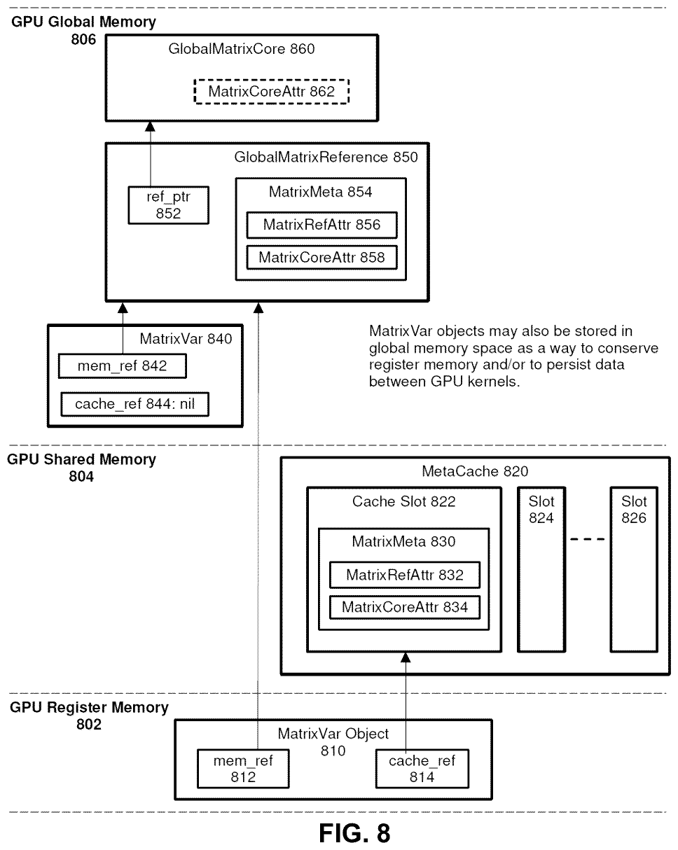

For example, FIG. 8 illustrates an exemplary MatrixVar object 840 (or simply “MatrixVar 840”) stored in an exemplary global memory 806 in accordance with some embodiments described herein. Storing MatrixVar object 840 in global memory 806 helps conserve space in shared memory 804 and register memory 802, and also allows MatrixVar 840 to persist across multiple GPU kernels because register memory 802 and shared memory 804 are not guaranteed to persist after a GPU kernel terminates. Note that however, because the GPU global memory is shared across GPU thread blocks (e.g., across all N SM blocks of the GPU in FIG. 1A), whereas MetaCache 820 resides in shared memory 804 (which is unique to each GPU execution block), it would not be appropriate for MatrixVar 840 in global memory 806 to request a cache slot in MetaCache 820 across various GPU thread blocks. This is because doing so may result in different MetaCache objects to assign different cache slots for MatrixMeta 854. Hence, the GPU numeric system may configure MatrixVar 840 to disable the use of cache_ref 844, when MatrixVar 840 is in global memory 806. Disabling cache_ref 844 can cause the GPU numerical system to access MatrixMeta 854 associated with MatrixVar 840 from global memory 806 via mem_ref 842 (instead of accessing a copy of MatrixMeta 854 stored in MetaCache 820 in shared memory 804 via cache_ref 844).

A program may still make use of MetaCache 820 to optimize access to a matrix referenced by MatrixVar 840 in global memory 806, by first instantiating another MatrixVar object 810 in register memory 802 so that MatrixVar object 810 aliases MatrixVar object 840 (e.g., by configuring mem_ref 812 to mirror mem_ref 842, thus also referencing GlobalMatrixReference 850). Allocating MatrixVar object 810 in register memory 802 configures the GPU numerical system to make use of MetaCache 820 to cache a copy of MatrixMeta 854 into shared memory 804. MatrixVar object 810 can behave as MatrixVar 840 because it also aliases GlobalMatrixReference 854, and has the benefit of being capable of utilizing cache_ref 814 to reserve and store a reference to a reserved cache slot in MetaCache 820.

Hence, the GPU numerical system may configure MetaCache 820 to reserve a cache slot 822 for MatrixVar object 810, and to copy MatrixMeta 854 into cache slot 822 (e.g., to be stored in MatrixMeta object 830). The GPU numerical system may then update cache_ref 814 of MatrixVar object 810 to reference MatrixMeta 830 in MetaCache 820. This allows the program to access a matrix's numeric array via MatrixMeta 830 in shared memory 804, without having to access MatrixMeta 854 in global memory 806.

In some embodiments, the GPU numerical system can also store MatrixVar objects in the shared memory to conserve register space in the register memory. Unlike MatrixVar objects stored in the global memory, it is possible for MatrixVar objects in the GPU's shared memory to reserve a cache slot in a MetaCache object.

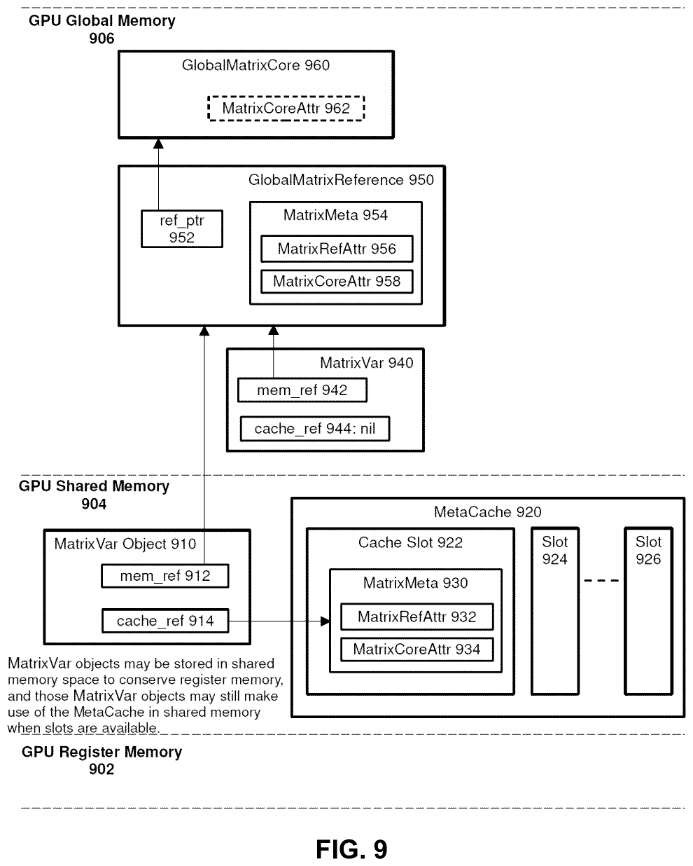

FIG. 9 illustrates an exemplary MatrixVar object 910 (or simply “MatrixVar 910”) stored in an exemplary shared memory 904 in accordance with some embodiments described herein. As mentioned earlier, an MatrixVar object 940 in global memory 906 may not use cache_ref 944 to hold a reference to a reserved cache slot within MetaCache 920 in shared memory 904. Thus, the GPU numerical system may make use of MetaCache 920 to cache a copy of MatrixMeta 954 into shared memory 904 by first using the aliasing assignment operation to configure MatrixVar object 910 to alias MatrixVar object 940 (e.g., by configuring mem_ref 912 to mirror mem_ref 942, thus also referencing GlobalMatrixReference 950). Then, either during the assignment operation or when attempting to access its matrix, the GPU numerical system can reserve a cache slot 922 within MetaCache 920 for MatrixVar 910, and can store a reference to cache slot 922 within cache_ref 914. The GPU numerical system can then utilize MatrixVar object 910 in shared memory 904 to operate on the numeric array referenced by MatrixVar 940 in global memory 906, without having to access MatrixMeta 954 in global memory 906 (e.g., by accessing MatrixMeta 930 in shared memory 904 instead, which stores a copy of MatrixMeta 954).

While this patent document contains many specifics, these should not be construed as limitations on the scope of any disclosed technology or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of performing a numerical operation, within a kernel of a graphics processing unit (GPU), on a reference matrix that references at least a subset of a primary numeric array, the method comprising:
creating, in a fast memory of the GPU, a first object that is accessible by a GPU program that performs a numerical operation on the reference matrix in the kernel of the GPU, wherein the first object corresponds to a data type that includes a function that implements the numerical operation on the reference matrix;
creating a second object in a global memory of the GPU for storing a first set of metadata of the reference matrix;
initializing a first attribute in the first set of metadata of the second object to a value that references a group of cells that are associated with the reference matrix, wherein the group of cells corresponds to at least a subset of cells in the primary numeric array allocated in the global memory of the GPU;
initializing a first reference variable in the first object to reference at least the first attribute in the second object; and
executing the numerical operation on the reference matrix in response to the GPU program issuing a GPU function call to the function of the first object.

2. The method of claim 1, wherein the fast memory is either a register memory of the GPU or a shared memory of the GPU.

3. The method of claim 1, wherein executing the numerical operation comprises performing a computation on a first cell in the group of cells of the reference matrix, based at least on the first attribute of the first set of metadata.

4. The method of claim 3, wherein executing the numerical operation on the cell based at least on the first attribute further comprises:
obtaining reference-matrix coordinates that correspond to the first cell of the reference matrix, wherein the reference-matrix coordinates are relative to cells referenced by the reference matrix;
computing, for the reference-matrix coordinates and based at least on the first attributes, array coordinates for accessing the first cell from the primary numerical array, wherein the array coordinates are relative to the primary numerical array; and
retrieving a reference pointer to the cell of the primary numeric array, using the array coordinates.

5. The method of claim 1,
wherein the first attribute in the first set of metadata of the second object specifies a matrix-shape vector associated with the reference matrix; and
wherein a respective element of the matrix-shape vector corresponds to a dimension of the reference matrix and specifies the number of cells along the corresponding dimension of the reference matrix.

6. The method of claim 5, wherein the first set of metadata of the second object further comprises a second attribute selected from the group composed of:
an array-stride vector associated with the reference matrix, wherein a respective element of the array-stride vector corresponds to a dimension of the reference matrix and specifies a number of cells to skip in the primary numerical array between adjacent cells of the reference matrix along the corresponding dimension; and
an array-offset vector associated with the reference matrix, wherein a respective element of the array-offset vector corresponds to a dimension of the reference matrix and specifies a starting position in the primary numerical array for the corresponding dimension of the reference matrix.

7. The method of claim 1, wherein the method further includes creating a third object in the global memory of the GPU to manage data and metadata resources for the primary numeric array in the global memory.

8. The method of claim 7,
wherein the third object includes a second set of metadata of the primary numeric array; and
wherein the method further comprises updating a second attribute in the second object to a value from the second set of metadata in the third object.

9. The method of claim 7, wherein the method further comprises:
receiving array coordinates that correspond to the first cell of the primary numeric array, wherein the array coordinates are relative to the primary numerical array; and
retrieving a reference pointer, to the first cell for the array coordinates, based at least on the second attribute of the second set of metadata.

10. The method of claim 1, wherein the function of the first object includes one of:
an element-wise operation;
a row-wise operation;
a column-wise operation;
a cross-product operation;
a linear algebra computation;
a statistical computation; and
a time-series computation.

11. A graphics processing unit (GPU) managing a data structure that facilitates performing numerical computations on a matrix within the GPU, comprising:
a fast memory, storing a first object that is accessible by a GPU program that performs a numerical operation on the reference matrix in the kernel of the GPU, wherein the first object corresponds to a data type that includes a function that implements the numerical operation on the reference matrix;
a global memory, storing a second object that is used to store a first set of metadata of the reference matrix; and
at least one GPU processing core coupled to both the fast memory and the global memory, and configured to run at least one processing thread, wherein the processing thread is further configured to:
create the first object in the fast memory;
create the second object in the global memory;
initialize a first attribute in the first set of metadata of the second object to a value that references a group of cells that are associated with the reference matrix, wherein the group of cells corresponds to at least a subset of cells in the primary numeric array allocated in the global memory of the GPU;
initialize a first reference variable in the first object to reference at least the first attribute in the second object; and
execute the numerical operation on the reference matrix in response to the GPU program issuing a GPU function call to the function of the first object.

12. The GPU of claim 11, wherein the fast memory is either a register memory of the GPU or a shared memory of the GPU.

13. The GPU of claim 11, wherein the at least one thread is configured to execute the numerical operation by performing a computation on a first cell in the group of cells of the reference matrix, based at least on the first attribute of the first set of metadata.

14. The GPU of claim 13, wherein the at least one thread is further configured to execute the numerical operation on the cell by:
obtaining reference-matrix coordinates that correspond to the first cell of the reference matrix, wherein the reference-matrix coordinates are relative to cells referenced by the reference matrix;
computing, for the reference-matrix coordinates and based at least on the first attributes, array coordinates for accessing the first cell from the primary numerical array, wherein the array coordinates are relative to the primary numerical array; and
retrieving a reference pointer to the cell of the primary numeric array, using the array coordinates.

15. The GPU of claim 11,
wherein the first attribute in the first set of metadata of the second object specifies a matrix-shape vector associated with the reference matrix; and
wherein a respective element of the matrix-shape vector corresponds to a dimension of the reference matrix and specifies the number of cells along the corresponding dimension of the reference matrix.

16. The GPU of claim 15, wherein the first set of metadata of the second object further comprises a second attribute selected from the group composed of:
an array-stride vector associated with the reference matrix, wherein a respective element of the array-stride vector corresponds to a dimension of the reference matrix and specifies a number of cells to skip in the primary numerical array between adjacent cells of the reference matrix along the corresponding dimension; and
an array-offset vector associated with the reference matrix, wherein a respective element of the array-offset vector corresponds to a dimension of the reference matrix and specifies a starting position in the primary numerical array for the corresponding dimension of the reference matrix.

17. The GPU of claim 11, wherein the global memory of the GPU further stores and uses a third object to manage data and metadata resources for the primary numeric array in the global memory.

18. The GPU of claim 17,
wherein the third object includes a second set of metadata of the primary numeric array;
and
wherein the at least one thread is further configured to update a second attribute in the second object to a value from the second set of metadata in the third object.

19. The GPU of claim 17, wherein the at least one thread is further configured to:
receive array coordinates that correspond to the first cell of the primary numeric array, wherein the array coordinates are relative to the primary numerical array; and
retrieve a reference pointer, to the first cell for the array coordinates, based at least on the second attribute of the second set of metadata.

20. The GPU of claim 11, wherein the function of the first object includes one of:
an element-wise operation;
a row-wise operation;
a column-wise operation;
a cross-product operation;
a linear algebra computation;
a statistical computation; and
a time-series computation.

21. The GPU of claim 11, wherein the GPU is one of the following:
a general-purpose GPU (GPGPU) processor;
a shared-memory multiprocessor or symmetric multiprocessor (SMP);
a stream processor (SP);
an integrated graphics processing unit (IGPU); and
a hybrid GPU.

22. A non-transitory computer-readable storage medium storing instructions that when executed by a computer cause the computer to perform a method for performing a numerical operation, within a kernel of a graphics processing unit (GPU), on a reference matrix that references at least a subset of a primary numeric array, the method comprising:
creating, in a fast memory of the GPU, a first object that is accessible by a GPU program that performs a numerical operation on the reference matrix in the kernel of the GPU, wherein the first object corresponds to a data type that includes a function that implements the numerical operation on the reference matrix;
creating a second object in a global memory of the GPU for storing a first set of metadata of the reference matrix;
initializing a first attribute in the first set of metadata of the second object to a value that references a group of cells that are associated with the reference matrix, wherein the group of cells corresponds to at least a subset of cells in the primary numeric array allocated in the global memory of the GPU;
initializing a first reference variable in the first object to reference at least the first attribute in the second object; and
executing the numerical operation on the reference matrix in response to the GPU program issuing a GPU function call to the function of the first object.

23. The non-transitory computer-readable storage medium of claim 22, wherein the fast memory is either a register memory of the GPU or a shared memory of the GPU.

24. The non-transitory computer-readable storage medium of claim 22, wherein executing the numerical operation comprises performing a computation on a first cell in the group of cells of the reference matrix, based at least on the first attribute of the first set of metadata.

25. The non-transitory computer-readable storage medium of claim 24, wherein executing the numerical operation on the cell based at least on the first attribute further comprises:
obtaining reference-matrix coordinates that correspond to the first cell of the reference matrix, wherein the reference-matrix coordinates are relative to cells referenced by the reference matrix;
computing, for the reference-matrix coordinates and based at least on the first attributes, array coordinates for accessing the first cell from the primary numerical array, wherein the array coordinates are relative to the primary numerical array; and
retrieving a reference pointer to the cell of the primary numeric array, using the array coordinates.

26. The non-transitory computer-readable storage medium of claim 22,
wherein the first attribute in the first set of metadata of the second object specifies a matrix-shape vector associated with the reference matrix; and
wherein a respective element of the matrix-shape vector corresponds to a dimension of the reference matrix and specifies the number of cells along the corresponding dimension of the reference matrix.

27. The non-transitory computer-readable storage medium of claim 26, wherein the first set of metadata of the second object further comprises a second attribute selected from the group composed of:
an array-stride vector associated with the reference matrix, wherein a respective element of the array-stride vector corresponds to a dimension of the reference matrix and specifies a number of cells to skip in the primary numerical array between adjacent cells of the reference matrix along the corresponding dimension; and
an array-offset vector associated with the reference matrix, wherein a respective element of the array-offset vector corresponds to a dimension of the reference matrix and specifies a starting position in the primary numerical array for the corresponding dimension of the reference matrix.

28. The non-transitory computer-readable storage medium of claim 22, wherein the method further includes creating a third object in the global memory of the GPU to manage data and metadata resources for the primary numeric array in the global memory.

29. The non-transitory computer-readable storage medium of claim 28,
wherein the third object includes a second set of metadata of the primary numeric array, and
wherein the method further comprises updating a second attribute in the second object to a value from the second set of metadata in the third object.

30. The non-transitory computer-readable storage medium of claim 28, wherein the method further comprises:
receiving array coordinates that correspond to the first cell of the primary numeric array, wherein the array coordinates are relative to the primary numerical array; and
retrieving a reference pointer, to the first cell for the array coordinates, based at least on the second attribute of the second set of metadata.

31. The non-transitory computer-readable storage medium of claim 22, wherein the function of the first object includes one of:
an element-wise operation;
a row-wise operation;
a column-wise operation;
a cross-product operation;
a linear algebra computation;
a statistical computation; and
a time-series computation.
